(19) United States
(12) Patent Application Publication
(10) Pub. No.: US 2025/0258772 A1
(43) Pub. Date: Aug. 14, 2025

(54) METHODS AND APPARATUS TO FACILITATE USE OF DYNAMIC COHERENCY MODELS FOR MEMORY OBJECTS

(71) Applicant: Openchip & Software Technologies S.L., Barcelona (ES)

(72) Inventors: Francesc Guim Bernat, Barcelona (ES); Edgar Gonzalez Pellicer, Barcelona (ES); Gaspar Mora Porta, Castellon de la Plana (ES); Violante Moschiano, Avezzano (IT); Satoru Tagaya, Barcelona (ES); Erich Ludwig Focht, Stuttgart (DE); Tommaso Vali, Sezze (IT)

(21) Appl. No.: 19/192,032

(22) Filed: Apr. 28, 2025

Related U.S. Application Data
(63) Continuation of application No. PCT/EP2025/057026, filed on Mar. 14, 2025.

(30) Foreign Application Priority Data
Mar. 14, 2025 (WO) PCT/EP2025/057026

(51) Int. Cl. G06F 12/0831

(52) U.S. Cl. CPC G06F 12/0831

(57) ABSTRACT

Systems, apparatus, articles of manufacture, and methods are disclosed to facilitate use of dynamic coherency models for memory objects. An example apparatus includes interface circuitry; instructions; and at least one programmable circuit to be programmed by the instructions to: access a request identifying a memory range and a coherency model; and apply the coherency model to a memory address in the memory range based on the coherency model setting.

### RELATED APPLICATION(S)

This patent arises from a continuation of International Patent Application No. PCT/EP2025/057026, which was filed on Mar. 14, 2025. Priority to International Patent Application No. PCT/EP2025/057026 is claimed. International Patent Application No. PCT/EP2025/057026 is incorporated herein by reference in its entirety.

### STATEMENT REGARDING GOVERNMENT SUPPORT

The work leading to this invention has received funding from the European Union-Next Generation, Important Projects of Common European Interest (IPCEI). In particular, this invention was made with government support under Grant UNICO-IPCEI-2023-001 funded by the European Union-Next Generation IPCEI.

### FIELD OF THE DISCLOSURE

This disclosure relates generally to computing devices and, more particularly, to methods and apparatus to facilitate use of dynamic coherency models for memory objects.

### BACKGROUND

Cache systems having multiple levels (L1 cache, L2 cache, etc.) are known. Cache systems typically include a persistent memory which retains large amounts of data but tends to require large amounts of time to access the data. One or more other layers of cache contain progressively smaller amounts of data with progressively faster access times. The cache closest to processor circuitry tends to be very fast access but stores a relatively small amount of data. A cache coherency protocol employs a cache coherency model to ensure data is correctly maintained throughout the system so that data that is modified is written back to the main memory at an appropriate time to avoid later processing of incorrect data.

In a multicore system with shared memory, compute elements can access data at a memory address of the main memory, store a copy of the data in one or more levels of cache (e.g., a local cache), modify the copied data, and write the modified data back to the memory address of the main memory. In multicore systems, the cache coherency protocol ensures that all compute elements accessing the same memory location see the most recent value written to it, and, thus, do not operate on an old version of data that has been modified. Data consistency refers to the overall ordering of memory operations across different memory locations to guaranty that all processor circuitry writes in a consistent sequence, even if they are accessing different data items. Thus, coherency corresponds to maintaining the same value for a single data location accessible to multiple cores, while consistency corresponds to the overall ordering of writes to any memory location across the system.

### BRIEF DESCRIPTION OF THE DRAWINGS

FIG. 1 is a block diagram of an example environment in which an example computing system operates to facilitate use of dynamic coherency models for memory objects.

FIG. 2 is a block diagram of an example implementation of one of the threads of FIG. 1.

FIG. 3 is a block diagram of an example implementation of the compute element of FIG. 1.

FIG. 4 is a block diagram of an example implementation of the caching agent of FIG. 1.

FIGS. 5A-5E illustrate example implementations of the caching agent of FIG. 1 in different locations of a computing system.

FIG. 6 is a flowchart representative of example machine readable instructions and/or example operations that may be executed, instantiated, and/or performed by example programmable circuitry to implement the compute element of FIG. 3.

FIG. 7 is a flowchart representative of example machine readable instructions and/or example operations that may be executed, instantiated, and/or performed by example programmable circuitry to implement the caching agent of FIG. 4.

FIG. 8 illustrates an example hardware arrangement of an example data center.

FIG. 9A illustrates an example arrangement of an example chip assembly of FIG. 8.

FIG. 9B illustrates an example arrangement of an example chip assembly of FIG. 8, adapted for high-performance computing applications.

FIG. 10 is a block diagram of an example processing platform including programmable circuitry structured to execute, instantiate, and/or perform the example machine readable instructions and/or perform the example operations of FIGS. 6 and/or 7 to implement one or more of the thread(s), the compute element, or the caching agent of FIGS. 2-4.

FIG. 11 is a block diagram of an example implementation of the programmable circuitry of FIG. 10.

FIG. 12 is a block diagram of another example implementation of the programmable circuitry of FIG. 10.

FIG. 13 is a block diagram of an example software/firmware/instructions distribution platform (e.g., one or more servers) to distribute software, instructions, and/or firmware (e.g., corresponding to the example machine readable instructions of FIGS. 6 and/or 7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

The following introduces examples of computer hardware for facilitate use of dynamic coherency models for memory objects, applicable in programmable architectures such as chiplet-based processors, System-on-chip (SoC) circuitry, System-in-Package (SiP) or System-on-Package (SoP) circuitry, and/or any other implementations of programmable circuitry.

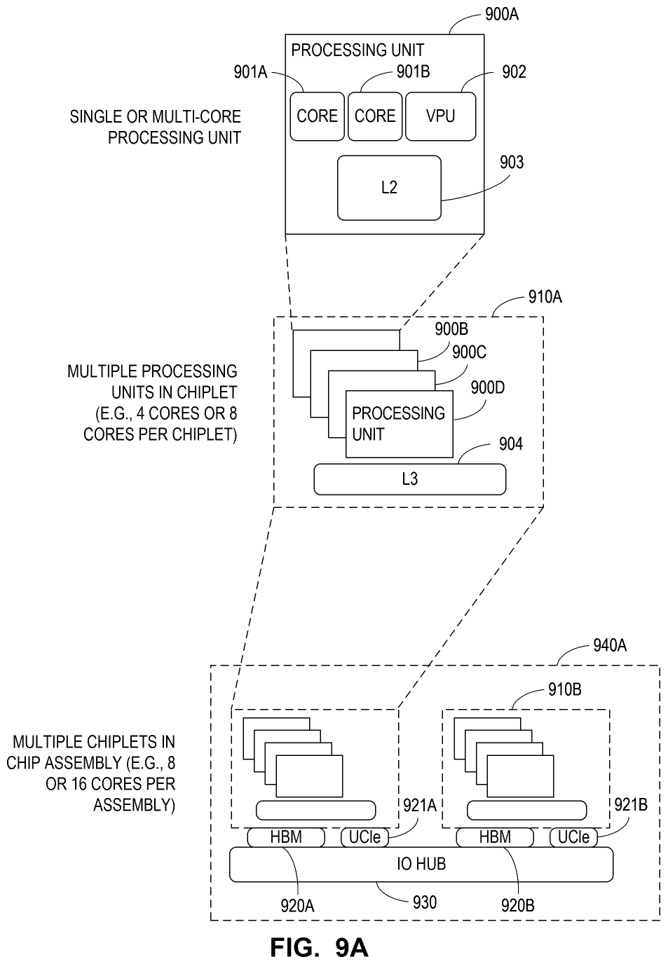

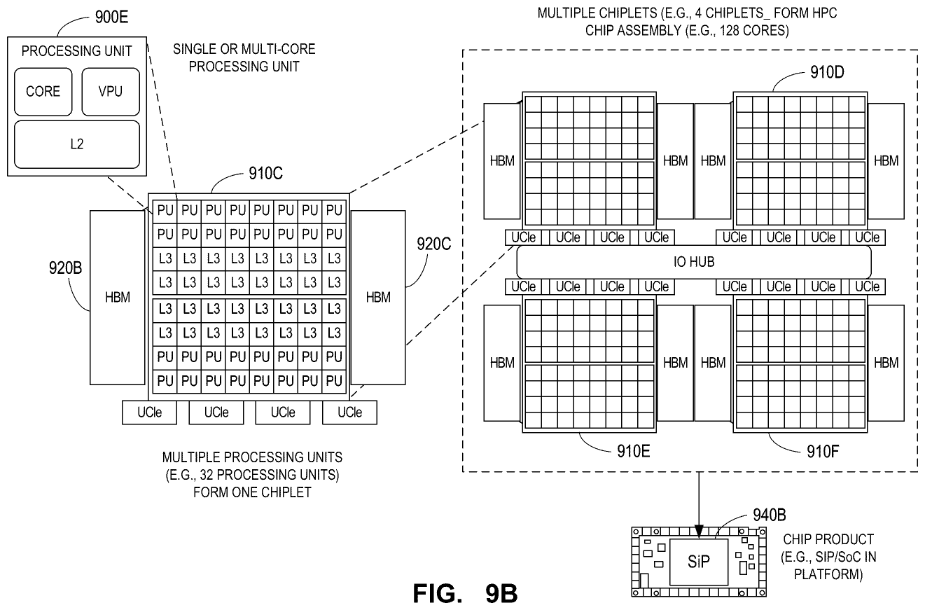

As used herein, a chiplet refers to any integrated circuit (IC) that has a modular structure to perform one or more specified functionalities and to be combinable with one or more other chiplets on an interposer or other substrate in a package. Examples of chiplets are compute chiplets that include programmable circuitry (e.g., one or more processor circuits, such as one or more cores, etc.) and supporting circuitry (e.g., local memory, etc.) to provide computational functionality (e.g., to execute a host OS, applications, etc.), memory chiplets that include memory accessible to one or more other chiplets, communication chiplets that include communication interfaces (e.g., input/output hubs, networks, etc.) to enable other chiplets to communicate with each other and/or to other devices external to the package, etc. Example multi-tier management architectures provide a flexible management architecture that is multi-tiered to enable management of chiplet-based compute devices that include various combinations of chiplets from various manufacturers. Example implementations of chiplets are further described below in conjunction with FIGS. 8, 9A, and 9B.

Hardware architecture and programming models perform operations by accessing data from a cache and/or memory, manipulating the accessed data, erasing the accessed data, overwriting the accessed data, etc. For example, a thread may include an instruction to read, modify, and/or write data corresponding to a particular memory address location. When a compute element of a computing system executes the thread, the compute element will access the data (or a copy of the data) corresponding to the memory address location of memory, manipulate the data in a cache or a buffer, and then write the manipulated data back to the memory at the memory address location. A compute element is a component, device, or other circuitry capable of executing and/or instantiating instructions or issuing execution results. A compute element may be a core, an accelerator, a processor, an accelerator, a central processing unit, a graphical processing unit, etc. Data can be retrieved and/or modified from various levels of the cache/memory system. The cache coherency protocol implements a cache coherency model to maintain correct data throughout the various levels of cache through various operations (e.g., marking data as “dirty,” flushing the cache, etc.).

This process becomes more complicated in a multicore, multichip, multi-chiplet, etc. system where data from a memory address can be accessed by different compute elements. For example, if different compute elements access data from the same memory location and separately manipulate the data in their local cache, the data in the two different caches for the same memory address will be different, leading to coherency issues. Coherency means that data stored in multiple caches are consistent and synchronized. To ensure coherency, a caching agent can utilize one or more coherence protocols, such as modified owned exclusive shared invalid (MOESI), modified shared invalid (MSI), modified shared exclusive invalid (MSEI), modified owned exclusive shared invalid forward (MOESIF), directly-based, token coherence, etc. Coherence protocols ensure that multiple compute elements accessing shared memory always see the most updated (correct) version of data, even if they have copies cached locally, by coordinating cache operations and notifying other compute elements when data is modified (e.g., dirty), and preventing inconsistencies across the computing device. Coherency models may leverage snooping on bus traffic to detect changes and sending invalidation or update messages to other caches storing the data.

Although sections of memory can be set up for coherency, through the use of coherency models, sections of memory can be set up for no coherency (also referred to as consistency). Consistency (or memory ordering) is based on the accuracy of data in a cache. As used herein, cache refers to one or more levels of a cache hierarchy including the main memory. Programmers develop instructions that ensure consistency without relying on the coherency models. For example, instructions can be written to ensure that two compute elements do not manipulate data in their local cache that correspond to the same memory address location at the same time. In this manner, before a compute element manipulates data for a memory location in its local cache, the data being manipulated in the cache is the same as the data in the main memory (i.e., the data is unchanged).

In some examples, hardware creates dependencies or performance glass jaws (e.g., ping pong effects) between threads implemented by different compute elements that may access similar parts of data stored in the coherent domain. A glass jaw and/or ping pong occurs when multiple compute elements repeatedly access and modify the same cache line, causing the cache line to bounce back and forth between respective caches. Such glass jaw and/or ping pong events cause corresponding cache line to be updated and invalidated in other compute element caches. However, coherency models to handle glass jaw and/or ping pong events may only be needed for a certain amount of time or to certain memory ranges based on how an application was written. Applications utilize data sets of different natures. In a multi-thread application, some of those data sets may only be used for one single thread or compute element. The same data objects may need or not need coherency across threads depending on the phase of the application.

In traditional computer systems, sections of memory can be set up for coherency, consistency, and/or a combination of coherency and consistency based on the code being implemented. However, once defined, the coherency/consistency mode of the sections of memory does not change in traditional computer systems. For example, if, for a given program, the memory is set up for consistency, the consistency will not change throughout the program. Although coherency may be needed for only a portion of time, if coherency is needed, then the memory is tagged for a coherence protocol for the entire time. However, utilizing a coherence protocol substantially increases overhead.

Reduced instruction set computer (RISC)-V architectures includes portions that are dynamically parametrizable. Examples disclosed herein utilize this dynamic parameterizable functionality of RISC-V to implement dynamic coherency models for memory. For example, using RISC-V, examples disclosed here can create instruction set architecture (ISA) extensions providing a new type of instruction and semantics. An ISA generally refers to rules that describe how a particular form of processor circuitry (such as a compute element) performs operations. For example, an ISA may define the types of machine-readable instructions, the maximum length of a machine-readable instruction, and the format of machine-readable instructions, which are supported by the compute element(s). The compute element(s) can therefore execute any instructions written in a high-level programming language that, when compiled, conforms to instructions in a low-level programmable language that comply with the rules set by the ISA.

Examples disclosed herein mitigate collateral ping pong effects of coherency by providing a mechanism that allows applications to dynamically tag certain memory objects (e.g., sections of memory) as consistent or coherent for durations of time. In this manner, memory objects can be tagged for coherency when needed and tagged for consistency when coherency is not needed, thereby conserving resources. For example, if an application is written in a manner to avoid coherency issues, the program can be executed in consistent memory, where coherency models are not implemented because the program was written to ensure coherency. However, if the code was not written to ensure coherency, then a coherency model is needed to ensure coherency. In some examples, hardware can detect strange, wrong, or inconsistent behaviors (e.g., too much ping) and notify the software of the behaviors to avoid coherency and/or consistency issues. In such examples, the software may instruct the hardware to look for particular issues in the program and/or to ignore other types of issues in the program. Examples disclosed herein provide an expansion of instructions and operations of a computing system to enable programmers to utilize dynamic and flexible use of memory according to application needed. Additionally, examples disclosed herein could be applied to coherency models between compute elements and other types of devices (e.g., input output (IO) devices connected to CXL), across fabric, to different System-on-chips (SoCs), across chiplets, etc.

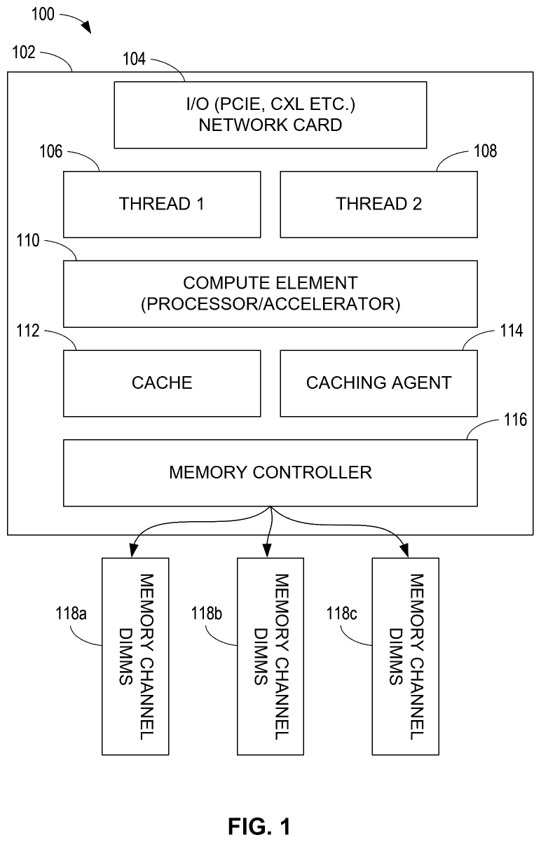

FIG. 1 illustrates an example computing system 100 (e.g., a package, a platform, etc.) to facilitate use of dynamic coherency models for memory objects. The computing system 100 includes an example system-on-chip 102. The system-on-chip 102 includes an example I/O network card 104, example threads 106, 108, an example compute element 110 (which may execute the threads 106. 108 in parallel), an example cache 112, an example caching agent 114, and an example memory controller 116. The system-on-chip 102 is connected to example memory channels (e.g., dual inline memory modules (DIMMs) 118a, 118b, 118c which may operate as main memory in the cache hierarchy. Although the computing system 100 of FIG. 1 includes two threads, a single compute element, a single cache, and three memory channels, the computing system 100 may include any number or type of threads, compute elements, caches, and/or memories. For example, although the example computing system 100 of FIG. 1 is shown with two threads, there can be any number of threads.

The I/O network card 104 of FIG. 1 acts as a bridge between the system-on-chip 102 and/or other devices (e.g., chips, platforms, I/O devices, chiplets, etc.). For example, the I/O network card 104 can send or receive data by facilitating communication with other devices in the system and/or on a network.

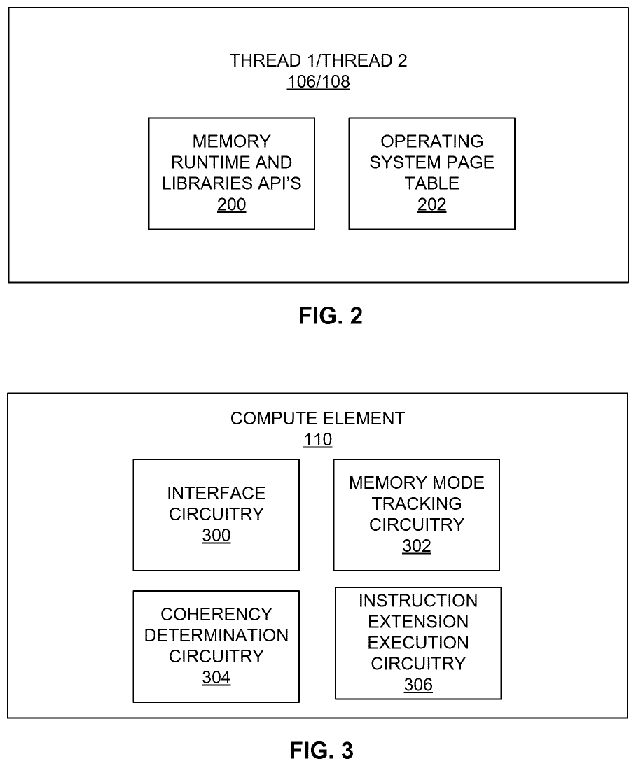

The threads 106, 108 of FIG. 1 are a sequences of instructions (e.g., corresponding to software and/or firmware) that the compute element 110 executes. The threads may exist at the operating system level or application level and can be managed by a thread scheduler. As further described below, the compute element 110 can execute the threads 106, while employing one or more dynamic coherency models for memory objects. As further described below in conjunction with FIG. 2, the threads 106, 108 may include memory runtime, library application programming interfaces (APIs), and/or operating system page tables for purposes of the dynamic coherency models and security.

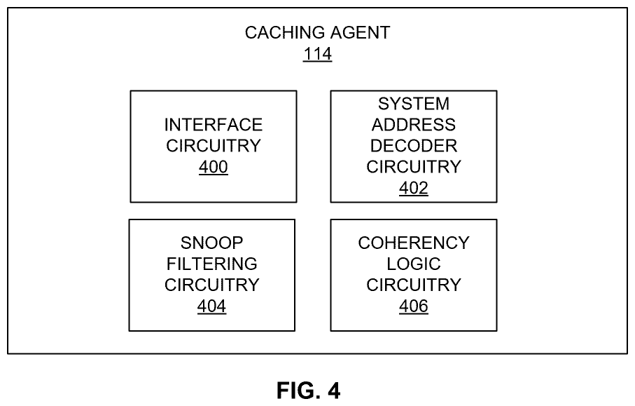

The compute element 110 of FIG. 1 may be implemented by programmable circuitry such as one or more chiplets, one or more cores, one or more accelerators, one or more microprocessors (e.g., a CPU, a GPU, a VPU and/or an XPU), one or more FPGAs and/or other hardware that executes instructions (e.g., the threads 106, 108). The compute element can execute an instruction from the threads 106, 108 to configure a new memory range to a particular coherency model for one or more threads based on the instruction so that the data from the memory range is handled using the particular coherency model. The compute element 110 may execute the instruction in ring 0 (e.g., by an operating system). Thus, the operating system may ensure that the application is setting up the configurations to resources owned by the application. The instruction may include a memory range associated with the memory mode (e.g., coherency or consistency), a memory type (e.g., a coherence protocol to utilize for the memory range), two IP addresses that correspond to execution of the current memory mode (e.g., after the end address ends, the previous memory mode or a default memory mode is established), a bitmask indicating which cores or hardware threads and/or compute elements are mapped into the memory mode, a bitmask indicating which chiplets and/or IO devices are part of the coherency model, a service level objective with quality of service (e.g., memory bandwidth associated with the memory range, and/or the type of coherence protocols for the memory range. A bitmask is a binary number that uses binary values (e.g., flags to identify the existence of a feature or trait, such as which compute elements or threads are mapped to a memory mode. A bitmask may also be referred to as a bit field, a bit set, a bit array, a binary field, a binary set, a binary array, binary feature identifier, a bit feature identifier, bit flags, binary flags, etc. The compute element 110 of this example tracks the IP address(es) for the memory modes associated to a particular range of instructions. In this manner, the compute element 110 can revert and/or reset the memory mode for the address range to a previous or default coherency protocol and/or model (e.g., consistency, no coherency, etc.) when the end instructions corresponding to the IP address is executed. When the compute element 110 is executing an instruction to access data corresponding to a memory address, the compute element 110 first determines if a copy of the data for the memory address is stored in the cache 112. If a copy is stored in the cache 112, the compute element 110 may perform one or more operations to the data based on the instructions. If a copy is not stored in the cache 112 (e.g., corresponding to a miss in the local cache), the compute element 110 instructs the memory controller 116 to access a copy of the data from the memory address line in one or more of the memory channel DIMMs 118a, 118b, 118c. The memory controller then writes the requested data into one or more levels of the cache hierarchy. An example implementation of the compute element 110 is further described below in conjunction with FIG. 3.

The example cache 112 of FIG. 3 is implemented by a temporary volatile memory in which the compute element 110 can store, access, and/or manipulate data associated with a particular memory address. The cache may include one or more levels of memory (e.g., L1 cache, L2 cache, L3 cache, etc.). In some examples, the cache 112 stores a copy of data from a particular memory address of the main memory (e.g., one or more of the memory channel DIMMs 118a, 118b, 118c), so that the compute element 110 can quickly and efficiently access and/or manipulate the data. After the compute element 110 is done operating on and/or otherwise using the data, the data in the cache is flushed (e.g., evicted, written, etc.) to the memory address of the corresponding memory channel DIMM(s) 118a, 118b, 118c (e.g., stored in the main memory). In some examples, the cache 112 may store a shared data set that is shared by different compute elements, threads, chiplets, etc. The cache 112 may be any level and/or type of cache (e.g., micro cache, level 1 cache, level 2 cache, level 3 cache, last level cache, etc.).

The caching agent 114 of FIG. 1 facilitates the use of dynamic coherency models for memory objects by managing memory configurations owning an address range. For example, the caching agent 114 configures a coherency setting (e.g., corresponding to coherency or no coherency) for a memory range by tagging and/or tracking the memory range (e.g., corresponding to a memory object) as coherent or consistent (e.g., not coherent) and/or for which threads/compute elements the memory object is coherent or consistent. Additionally, when a memory object is tagged for coherency, the caching agent 114 can track and/or monitor the type of coherency model used.

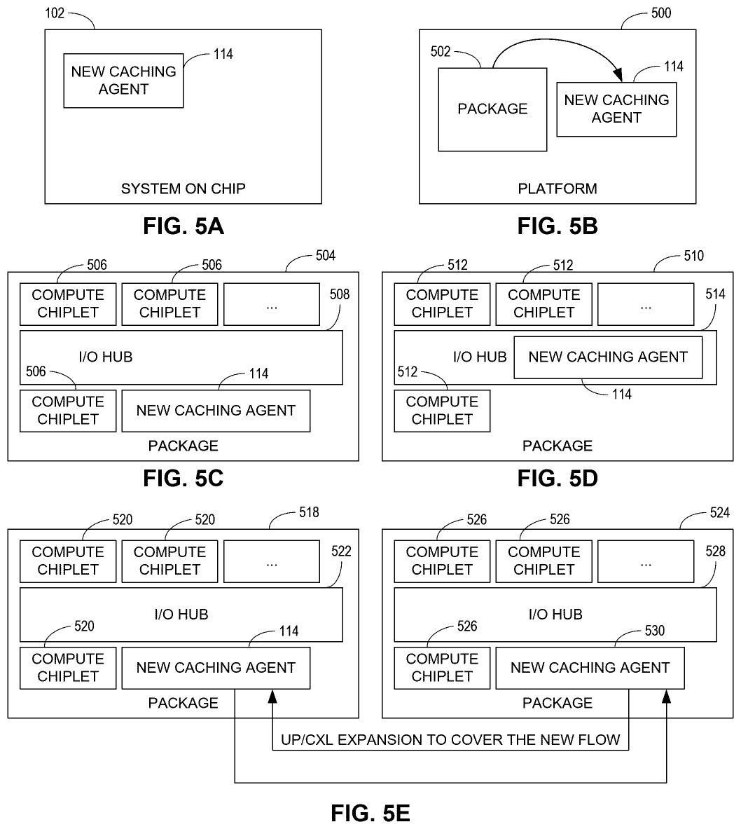

The caching agent 114 of this example includes a hardware API that allows the compute element 110 to register the memory mode address space. The API registers memory modes into a system address decoder, as further described below. In the case of failure on creation, the caching agent 114 returns the error to the compute element 110. However, the returning of the error may result in a conflict with another definition with another set of compute elements and/or a conflicting definition with another memory mode range. Accordingly, the system address decoder registers the dynamic memory space to identify potential conflicting memory range definitions (e.g., across different sets of compute elements or between two registrations). Additionally, the caching agent 114 may execute memory requests from the compute element 110 based on the requested memory mode. In the example of FIG. 1, the caching agent 114 emulates no coherency from the compute element flow perspective to minimize computing impact on the compute element 110. For example, if an application says that a memory range is no coherent for a first thread running on the compute element 110, if the first thread requests ownership of a memory line within the memory range, the compute element 110 will not send the request to the caching agent 114. Rather, the compute element 110 return to an execution unit of the compute element an acknowledgement mimicking the response that the caching agent 114 would have provided to save coherency messages between the compute element and the caching agent 114 In some examples, functionality of the caching agent 114 may be implemented in the compute element 110. In such examples, compute element 110 may always be aware of the coherency states of each memory object. The caching agent 114 is further described below in conjunction with FIG. 4.

The memory controller 116 of FIG. 1 may be a single memory controller or multiple memory controllers (e.g., for different memories of the computing system 100). Based on instructions from the compute element 110, the memory controller 116 can read and/or write data to a memory address line of one or more of the memory channel DIMMs 118a, 118b, 118c. For example, for accessing, the memory controller 116 can determine which memory channel DIMMs 118a, 118b, 118c corresponds to a memory address line, read the data from the corresponding DIMM, and store a copy of the read data into the cache 112. Additionally, for eviction, flushing, writing, etc. the memory controller 116 can determine which memory channel DIMMs 118a, 118b, 118c corresponds to a memory address line, and write data from the cache 112 corresponding to the memory address line into the determined memory channel DIMM 118a, 118b, 118c at the memory address line.

The memory channel DIMMs 118a, 118b, 118c of FIG. 1 include random access memory. Each memory cell of the memory channel DIMMs 118a, 118b, 118c corresponds to a memory address. Data is stored into a location corresponding to a memory address of the memory channel DIMMs 118a, 118b, 118c. In some examples, the memory channels DIMMs 118a, 118b, 118c may be replaced with one or more different types of memory channels.

FIG. 2 is a block diagram of an example implementation one or more of the threads 106, 108 of FIG. 1. The threads 106, 108 of FIG. 2 may be instantiated (e.g., creating an instance of, bring into being for any length of time, materialize, implement, etc.) by instructions executed by programmable circuitry. For example, programmable circuitry may be implemented by a Central Processor Unit (CPU) a chiplet, an array of chiplets, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the thread(s) 106, 108 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers. The threads 106, 108 include example memory runtime and libraries APIs 200 and example operating system page table circuitry 202.

The memory runtime and libraries APIs 200 include programming language that provides a mechanism (e.g., via pragmas) to allow an instruction to specify memory ranges or objects that are subject to a particular memory mode and to configure different parameters for the memory range or object. As used herein, a pragma is a directive that provides additional information to the compiler to specify how a compiler should process its input, allowing a programmer to influence specific aspects of the compilation process. A pragma enables specific control over the compilation process beyond what is traditionally available in the programming language itself. The memory runtime and libraries APIs 200 create the address space coherency type instruction, that when executed by a compute element, cause a memory object to temporarily correspond to a particular type of coherent protocol for one or more threads/compute elements.

The operating system page table 202 of FIG. 2 includes information including the coherency domains that are created when executed and/or implemented, which compute elements and/or threads own the coherency domains, etc. The operating system page table 202 includes such information to avoid security gaps (e.g., unauthorized or unintended use) by ensuring that the software stack requiring changes to a memory range corresponds to (e.g., is owned by) the process and the cores that are mapped to the process are authorized for the process. The operating system may be responsible for allocation of objects and check that the software stack is using the objections without violating other applications. A software stack includes the operating system, a compiler, libraries, and/or an application. The operating system may be operating within the threads 106, 108 and/or beneath the threads. The operating system may be part of a virtual machine (VM) and/or may be outside of the virtual execution environment (e.g., in the context of a container).

FIG. 3 is a block diagram of an example implementation of the compute element 110 of FIG. 1 to cause memory ranges to implement dynamic coherency models. The compute element 110 of FIG. 3 may be instantiated (e.g., creating an instance of, bring into being for any length of time, materialize, implement, etc.) by programmable circuitry. For example, programmable circuitry may be implemented by a Central Processor Unit (CPU) a chiplet, an array of chiplets, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the compute element 110 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers. The compute element 110 includes example interface circuitry 300, example memory mode tracking circuitry 302, and example instruction extension execution circuitry 306.

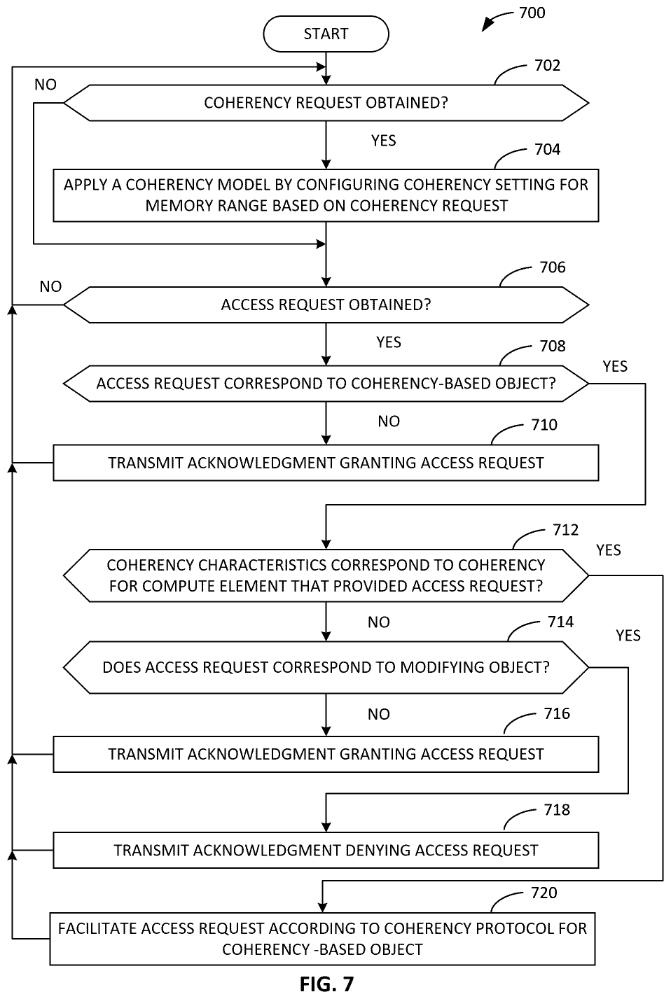

The interface circuitry 300 of FIG. 3 interfaces with the other components of the system-on-chip 102. For example, the interface circuitry 300 can obtain instructions, can transmit requests and/or receive acknowledgments and/or other data from/to the caching agent 114 and/or from/to the thread(s) 106, 108, access and/or manipulate data from/to the cache 112 and/or main memory, transmit instructions to the memory controller 116, etc. In some examples, the interface circuitry 300 is instantiated by programmable circuitry executing memory access monitoring instructions and/or configured to perform operations such as those represented by the flowchart(s) of FIG. 6.

The memory mode tracking circuitry 302 of FIG. 3 tracks the IP address (e.g., the starting memory address for a particular memory range) for the memory modes associated with a particular range of instructions. As further described below, the instruction extension execution circuitry 306 can execute coherency instructions from one or more of the threads 106, 108. The coherency instruction may correspond to a set coherency instruction or a reset (e.g., revert) coherency instruction. The memory mode tracking circuitry 302 determines when a set coherency instruction has been obtained for a memory range and monitors the execution of instructions for the reception of an end coherency instruction (also referred to as a reset coherency instruction) for the memory range (which identifies the end of coherency for the memory range). When a set coherency instruction has been executed/obtained, the memory mode tracking circuitry 302 transmits a coherency request to the caching agent 114 to tag the memory range for coherency based on the coherency instruction. After the memory mode tracking circuitry 302 determines that end coherency instruction (e.g., a revert instruction that signifies the end of the coherency mode for a memory range) for a memory range has been obtained/executed, the memory mode tracking circuitry 302 reverts the memory mode for the memory range by transmitting a request to the caching agent 114 that identifies the memory range to revert back to a default coherency protocol and/or model (e.g., no coherency). In some examples, the memory mode tracking circuitry 302 is instantiated by programmable circuitry executing memory access monitoring instructions and/or configured to perform operations such as those represented by the flowchart(s) of FIG. 6.

The coherency determination circuitry 304 of FIG. 3 can determine the type of coherency that a given address or address range has. For example, the coherency determination circuitry 304 can communicate, via the interface circuitry 300, with the caching agent 114 to determine coherency types of address ranges (e.g., by access a stored data in the caching agent 114 that tracks coherency of memory ranges). In this manner, the coherency determination circuitry 304 can prevent access to data in a memory address for a clashing coherency mode (e.g., when the compute element 110 executes a thread that assumes coherency for a memory address that is not tagged for coherency or vice versa).

The instruction extension execution circuitry 306 of FIG. 3 executes instructions corresponding to memory mode coherency for a memory range (e.g., a memory object). For example, when the thread 106, 108 includes a coherency instruction, the instruction extension execution circuitry 306 executes the coherency instruction to set or reset coherency for a memory range based on the coherency instruction. The instructions are executed via a system call in the operating system (OS) implemented in the computer elements of the computing system 100. The OS may check rights for the application. For example, an application may generate a system call to change memory coherency, then the OS performs corresponding checks (e.g., to ensure the application owns the memory range of the system call, and then the OS performs execution of the instruction. An example of different set and/or reset instructions and/or ISAs is shown in the below Table 1

TABLE 1
Coherency instructions

| # | Instruction Type | Instruction |
|---|---|---|
| 1 | Setup a coherent protocol for | set_ca_mem @x, offset, |
| | a particular memory range | coherency_model |
| 2 | Setup a coherent protocol for | set_ca_mem_cores @x, offset |
| | a particular memory range for | coherency_model, core-bitmask |
| | a set of cores | |
| 3 | Setup a coherent protocol for | set_ca_mem_chiplet @x, offset |
| | a particular memory range for | coherency_model, chiplet-bitmask |
| | a set of chiplets | |
| 4 | Setup a coherent protocol for | set_ca_mem_ce_io @x, offset |
| | a particular memory range for | coherency_model, core-bitmask, |
| | a set of cores and I/O devices | IO-bitmask |
| 5 | Setup a coherent protocol for | set_ca_mem_ce_io @x, offset |
| | a particular memory range for | coherency_model, chiplet-bitmask, |
| | a set of chiplet and I/O | IO-bitmask |
| | devices | |
| 6 | Reset or revert the coherent | Reset_ca @x |
| | protocol for a particular | |
| | address range. | |

In the above Table 1, @x corresponds to the starting memory address of a memory object or memory range for the memory mode, offset corresponds to the size of the memory object or memory range for the memory mode (e.g., the offset from the starting memory address), and bitmask corresponds to the set of components (e.g., compute elements/threads, chiplets, IO devices) that the memory mode applies to. The instruction extension execution circuitry 306 executes the first coherency instruction to set up a memory range for a particular coherency model for all compute elements and/or threads in the computing system 100. The instruction extension execution circuitry 306 executes the second coherency instruction to set up a memory range for a particular coherency model for a subgroup of compute elements and/or threads in the computing system 100. The instruction extension execution circuitry 306 executes the third coherency instruction to set up a memory range for a particular coherency model for a subgroup of chiplets in the computing system 100. The instruction extension execution circuitry 306 executes the fourth coherency instruction to set up a memory range for a particular coherency model for a subgroup of compute elements and/or IO devices in the computing system 100. The instruction extension execution circuitry 306 executes the fifth coherency instruction to set up a memory range for a particular coherency model for a subgroup of chiplets and/or IO devices in the computing system 100. The instruction extension execution circuitry 306 executes the sixth coherency instruction to reset or revert a memory range to a default coherency protocol. In some examples, the default coherency protocol and/or model corresponds to consistency/no coherency. However, the default coherency protocol and/or model may correspond to a different coherency protocol.

Although the bitmask of the second instruction of Table 1 identifies a set of compute elements to be implemented by a coherency model, the second instruction may identify a set of threads to be implemented by a coherency model. For example, the caching agent 114 could implement a variance where the coherency setting can be per thread set. In such an example, there may be different policies for different threads (e.g., an event for different applications and/or processes). For example, a first process identifier for a first thread is not coherent for memory range [a, b] and a second process identifier for the first thread is coherent for memory range [a, b]. In such examples, the caching agent can store a list of ranges indexed per process identifier and thread identifier. In some examples, the instruction extension execution circuitry 306 is instantiated by programmable circuitry executing memory access monitoring instructions and/or configured to perform operations such as those represented by the flowchart(s) of FIG. 6.

In some examples, model specific registers (MSRs) can be used instead or, or in addition to, instructions or ISAs. In such examples, a first MSR (MSR1) can operate as a trigger, to trigger actions and additional MSRs can provide parameters, as shown in the below Table 2.

TABLE 2
Coherency-based MSRs

| # | Action Type | MSRs |
|---|---|---|
| 1 | Setup a coherent protocol | MSR1 = op01 |
| | for a particular memory range | MSR2 = @x |
| | | MSR3 = offset |
| | | MSR4 = coherency_model |
| 2 | Setup a coherent protocol | MSR1 = op02 |
| | for a particular memory | MSR2 = @x |
| | range for a set of cores | MSR3 = offset |
| | | MSR4 = coherency_model |
| | | MSR5 = core-bitmask |
| 3 | Setup a coherent protocol | MSR1 = op03 |
| | for a particular memory | MSR2 = @x |
| | range for a set of chiplets | MSR3 = offset |
| | | MSR4 = coherency_model |
| | | MSR5 = chiplet -bitmask |
| 4 | Setup a coherent protocol | MSR1 = op04 |
| | for a particular memory | MSR2 = @x |
| | range for a set of cores | MSR3 = offset |
| | and I/O devices | MSR4 = coherency_model |
| | | MSR5 = IO -bitmask |
| 5 | Setup a coherent protocol | MSR1 = op05 |
| | for a particular memory | MSR2 = @x |
| | range for a set of | MSR3 = offset |
| | chiplet and I/O devices | MSR4 = coherency_model |
| | | MSR5 = chiplet -bitmask |
| | | MSR6 = IO-bitmask |
| 6 | Reset the coherent protocol | MSR1 = op06 |
| | for a particular address range. | MSR2 = @x |

In such examples, the instruction extension execution circuitry 306 can set values in the MSRs to configure a memory range for coherency based on an instruction from a thread. For example, if the instruction extension execution circuitry 306 obtains an instruction to set a coherency protocol to implement a coherency model for a particular memory range for a set of cores, the instruction extension execution circuitry 306 stores a value corresponding to the op02 in the MSR1, sets the starting address line for the coherency model in the MSR2, sets the offset for the end address line corresponding to the memory range in the MSR3, stores a value corresponding to the coherency model in the MSR4, and stores a core bitmask identifying which cores to need to operate the coherency model in the MSR5. In such examples, the caching agent 114 can identify the details of a coherency model for a particular memory range based on the values stored in the MSRs. The MSRs may be located in the compute element 110, in the caching agent 114 and/or in another location of the system on chip 102. Some examples can track coherency by mapping the actual configuration and the status registers of memory, cache, NoC components, etc. and control them directly. Such examples can be implemented by logic within the system on chip 102 to configure into the software (e.g., a kernel, a driver, etc.) at low-level and expose a high-level API with commands as expressed in the above Table 2.

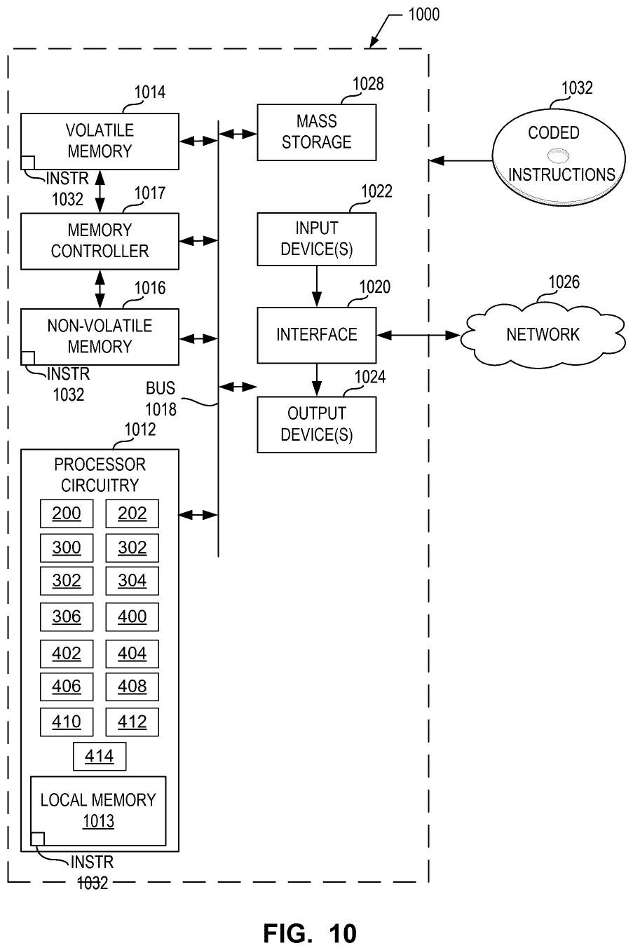

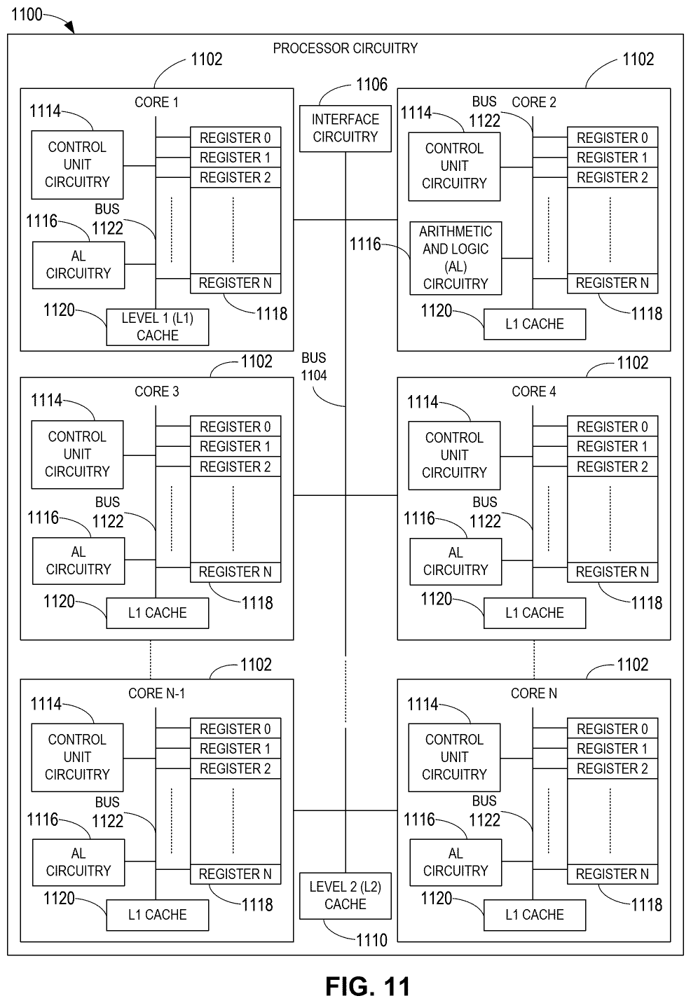

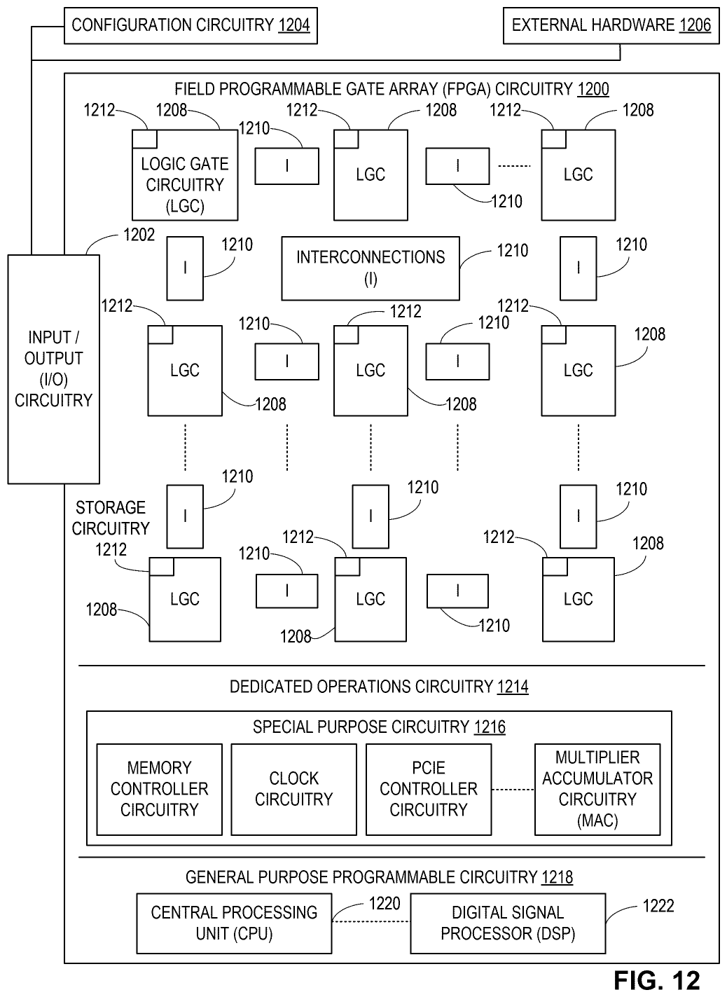

In some examples, the compute element 110 includes means for transmitting, means for tracking, means for determining coherency and means for executing. For example, the means for transmitting may be implemented by the interface circuitry 300, the means for tracking may be implemented by the memory mode tracking circuitry 302, the means for determining coherency may be implemented by the coherency determination circuitry 304, and the means for executing may be implemented by the instruction extension execution circuitry 306. In some examples, the interface circuitry 300, the memory mode tracking circuitry 302, the coherency determination circuitry 304, and/or the instruction extension execution circuitry 306 may be instantiated by programmable circuitry such as the example programmable circuitry 1012 of FIG. 10. For instance, the interface circuitry 300, the memory mode tracking circuitry 302, the coherency determination circuitry 304, and/or the instruction extension execution circuitry 306 may be instantiated by the example microprocessor 1100 of FIG. 11 and/or the chiplet of FIGS. 9A and/or 9B executing machine executable instructions such as those implemented by at least blocks 602-616 of FIG. 6. In some examples, the interface circuitry 300, the memory mode tracking circuitry 302, the coherency determination circuitry 304, and/or the instruction extension execution circuitry 306 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the interface circuitry 300, the memory mode tracking circuitry 302, the coherency determination circuitry 304, and/or the instruction extension execution circuitry 306 may be instantiated by any other combination of hardware, software, and/or firmware. For example, the interface circuitry 300, the memory mode tracking circuitry 302, the coherency determination circuitry 304, and/or the instruction extension execution circuitry 306 may be implemented by at least one or more hardware circuits (e.g., processor circuitry, discrete and/or integrated analog and/or digital circuitry, an FPGA, an ASIC, an XPU, chiplet(s), core(s), a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

FIG. 4 is a block diagram of an example implementation of the caching agent 114 of FIG. 1. The caching agent 114 of FIG. 4 may be instantiated (e.g., creating an instance of, bring into being for any length of time, materialize, implement, etc.) by programmable circuitry. For example, programmable circuitry may be implemented by a Central Processor Unit (CPU) a chiplet, an array of chiplets, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the caching agent 114 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers. The caching agent 114 of FIG. 4 includes example interface circuitry 400, example system address decoder circuitry 402, example snoop filtering circuitry 404, and example coherency logic circuitry 406.

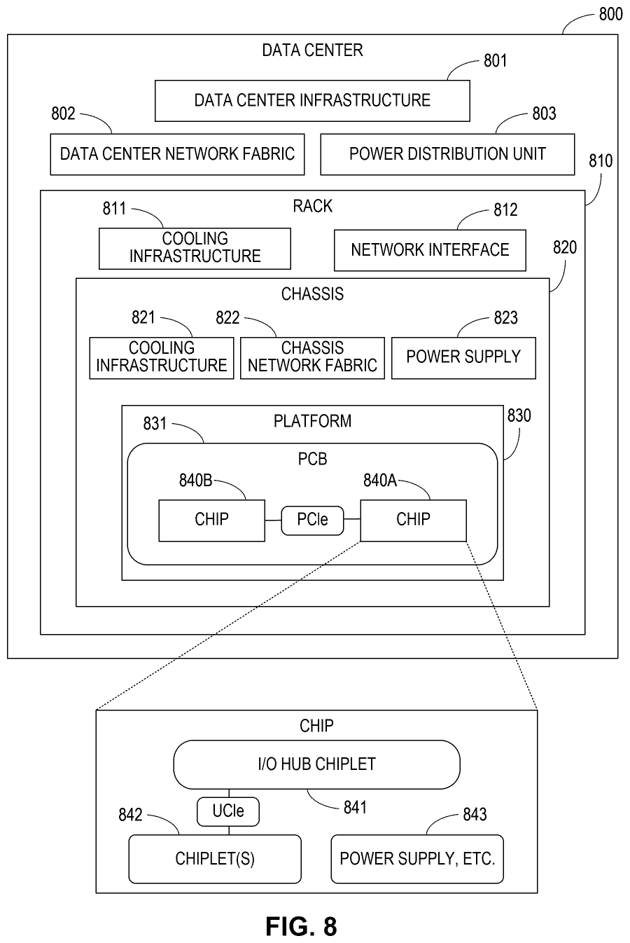

The interface circuitry 400 of FIG. 4 obtains coherency requests and/or access requests from the compute element 110. For example, when the compute element 110 executes an instruction to set a range of memory for coherency, the compute element 110 transmits a request to the interface circuitry 400. Additionally, when the compute element 110 executes an instruction to access and/or manipulate data stored in a memory address of memory, the compute element 110 transmits an access request to the interface circuitry 400. Additionally, the interface circuitry 400 can transmit acknowledgments to the compute element 110 for the requests. In some examples, the interface circuitry 400 is instantiated by programmable circuitry executing interface instructions and/or configured to perform operations such as those represented by the flowchart(s) of FIG. 7.

The system address decoder circuitry 402 of FIG. 4 registers the memory modes for memory ranges based on coherency requests from the compute element 110. The system address decoder circuitry 402 can be used to identify potential conflicting memory range definitions (e.g., across different sets of cores or between two registrations). After a coherency request is obtained, the system address decoder circuitry 402 processes the coherency request to determine details related to the coherency so that the address decoder circuitry 402 can configure a coherency setting for the memory range based on the coherency request by tagging or otherwise tracking the coherency details and/or implementing coherency for the memory range based on the coherency details. For example, the coherency request includes one or more of a memory address range, a coherent protocol type, an identification (e.g., a bitmask) of compute elements, threads, chiplets, and/or IO devices. After the system address decoder circuitry 402 obtains a reset request, the system address decoder circuitry 402 untags or otherwise determines that coherency has ended for the corresponding memory range. In some examples, the system address decoder circuitry 402 may include storage (e.g., registers) that stores information for tracking memory ranges that have been tagged for coherency for one or more threads and/or compute elements. In this manner, the compute element 110 can access the data to identify information related to coherency of a memory range, as further described above in conjunction with FIG. 3. In some examples, the system address decoder circuitry 402 is instantiated by programmable circuitry executing interface instructions and/or configured to perform operations such as those represented by the flowchart(s) of FIG. 7.

The snoop filtering circuitry 404 of FIG. 4 performs snooping protocols for data access and/or manipulation requests to data corresponding to a memory range that is tagged for coherency. The snoop filtering circuitry 404 can snoop other computing devices (e.g., other compute elements in the same or a different system) that implement threads that have copies of data corresponding to a memory line and give ownership to a particular thread. A snooping protocol may include monitoring a shared bus to detect when another compute element accesses data that is also cached in the local cache 112. In this manner, the snooping filter circuitry 404 can invalidate and/or update the local copy of data based on the monitoring. After snooping, the snoop filtering circuitry 404 can give ownership of the memory line to a particular thread and/or compute element and cause the other compute elements to evict the data from their local caches. In this manner, the thread and/or compute element can manipulate the data and ensure that all the copies of the data across compute devices are the same. In some examples, the snoop filtering circuitry 404 is instantiated by programmable circuitry executing interface instructions and/or configured to perform operations such as those represented by the flowchart(s) of FIG. 7.

The coherency logic circuitry 406 of FIG. 4 manages access requests (e.g., to read data, write data, modify data, etc.) from the compute element 110 based on memory modes associated with memory ranges. For example, when the compute element 110 transmits a request to write to a memory address, the coherency logic circuitry 406 interfaces with the system address decoder circuitry 402 to determine if the memory address and/or thread that the compute element 110 executes corresponds to coherence (e.g., a memory range that has been tagged for coherency). If the memory address does not correspond to coherence, the coherency logic circuitry 406 grants the request via an acknowledgement. If the memory address corresponds to a coherency memory mode, the coherency logic circuitry 406 facilitates the approval or denial of the request based on the memory mode for the memory address. For example, if the request is a read only request, the coherency logic circuitry 406 grants the request. If the request is a write and/or manipulate request, the coherency logic circuitry 406 only grants the request if the thread, compute element, IO devices, chiplet, etc. making the request is included in the coherency information (e.g., covered by the bitmask, if there is one). If access is granted, the coherency logic circuitry 406 may instruct the snoop filtering circuitry 404 to perform snoop filtering to ensure coherency for the data across caches. In some examples, coherency logic circuitry 406 is instantiated by programmable circuitry executing interface instructions and/or configured to perform operations such as those represented by the flowchart(s) of FIG. 7.

In some examples, the caching agent 114 includes means for means for accessing requests, means for configuring coherency settings, means for snooping and/or means of facilitating a request. For example, the means for accessing may be implemented by the interface circuitry 400, the means for configuring may be implemented by the system address decoder 402, the means for snooping may be implemented by the snoop filtering circuitry 404, and the means for facilitating a request may be implemented by the coherency logic circuitry 406. In some examples, the means for accessing may include means for transmitting and the means for configuring may include means for determining whether a memory address of an access request corresponds to a memory objected marked for coherency. In some examples, the interface circuitry 400, the system address decoder circuitry 402, the snoop filtering circuitry 404, and/or the coherency logic circuitry 406 may be instantiated by programmable circuitry such as the example programmable circuitry 1012 of FIG. 10. For instance, the interface circuitry 400, the system address decoder circuitry 402, the snoop filtering circuitry 404, and/or the coherency logic circuitry 406 may be instantiated by the example microprocessor 1100 of FIG. 11 and/or the chiplet of FIGS. 9A and/or 9B executing machine executable instructions such as those implemented by at least blocks 702-720 of FIG. 7. In some examples, the interface circuitry 400, the system address decoder circuitry 402, the snoop filtering circuitry 404, and/or the coherency logic circuitry 406 may be instantiated by hardware logic circuitry, which may be implemented by an ASIC, XPU, chiplet(s), core(s), or the FPGA circuitry 1200 of FIG. 12 configured and/or structured to perform operations corresponding to the machine readable instructions. Additionally or alternatively, the interface circuitry 400, the system address decoder circuitry 402, the snoop filtering circuitry 404, and/or the coherency logic circuitry 406 may be instantiated by any other combination of hardware, software, and/or firmware. For example, the interface circuitry 400, the system address decoder circuitry 402, the snoop filtering circuitry 404, and/or the coherency logic circuitry 406 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

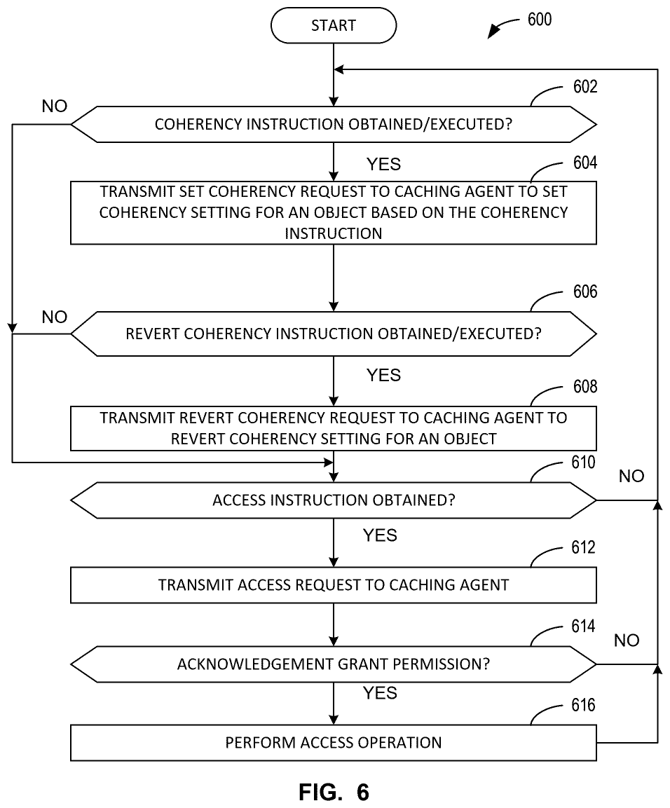

FIGS. 5A-5E illustrate alternative implementations of the caching agent 114 of FIG. 2. FIG. 5A includes the system on chip 102 and the caching agent 114 of FIG. 1. FIG. 5B includes an example platform 500, an example package 502, and the caching agent 114 of FIG. 1. FIG. 5C includes an example package 504, example compute chiplets 506, an example IO hub 508, and the caching agent 114 of FIG. 1. FIG. 5D includes an example package 510, example compute chiplets 512, an example IO hub 514, and the caching agent 114 of FIG. 1. FIG. 5E includes example packages 518, 524, example chiplets 520, 526, example IO hubs 522, 528, an example caching agent 530, and the example caching agent 114 of FIG. 1.

Each configuration has a potential location of the caching agent 114 for different operations. For example, in FIG. 5A, the caching agent 114 is implemented in the system on chip 102, as described above in conjunction with FIG. 1. In this manner, the caching agent 112 can facilitate dynamic memory modes for compute elements inside the system on chip 102. In FIG. 5B, the caching agent 114 is implemented on the platform 500 outside of the package 502 (which may include chiplets, systems-on-chips, IO hubs, etc.). In this manner, the caching agent 112 can facilitate dynamic memory modes for compute elements inside the package 502 and/or between the system on chip of FIG. 5A and external sources (e.g., IO devices). In FIG. 5C, the caching agent 114 is implemented within the package 504. In this manner, the caching agent 114 can implement memory modes across the chiplets 506. In some examples, such as FIG. 5D, the caching agent 114 is implemented in the IO hub to implement memory modes across the chiplets 512. However, the caching agent 114 may additionally or alternatively be implemented in one or more of the chiplets 506, 512. In FIG. 5E, the caching agent 114 of the package 518 communicates with the caching agent 530 of the package 524 using unified payments interface (UPI) or compute express link (CXL) capabilities to implement memory modes for coherency across different chips.

While an example manner of implementing one or more of the thread(s) 106, 108, the compute element 110, and/or the caching agent 114 of FIG. 1 is illustrated in FIGS. 2, 3 and/or 4 one or more of the elements, processes, and/or devices illustrated in FIGS. 2, 3, and/or 4 may be combined, divided, re-arranged, omitted, eliminated, and/or implemented in any other way. Further, the memory runtime and libraries APIs 2100, the operating system page table 202, the interface circuitry 300, the memory mode tracking circuitry 302, the coherency determination circuitry 304, the instruction extension execution circuitry 306, the interface circuitry 400, the system address decoder circuitry 402, the snoop filtering circuitry 404, the coherency logic circuitry 406, and/or, more generally, the example the thread(s) 106, 108, the compute element 110, and/or the caching agent 114 of FIGS. 2, 3, and/or 4, may be implemented by hardware alone or by hardware in combination with software and/or firmware. Thus, for example, any of the memory runtime and libraries APIs 2100, the operating system page table 202, the interface circuitry 300, the memory mode tracking circuitry 302, the coherency determination circuitry 304, the instruction extension execution circuitry 306, the interface circuitry 400, the system address decoder circuitry 402, the snoop filtering circuitry 404, the coherency logic circuitry 406, and/or, more generally, the example the thread(s) 106, 108, the compute element 110, and/or the caching agent 114 of FIGS. 2, 3, and/or 4, could be implemented by programmable circuitry, such as one or more chiplets, one or more processor cores, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)) vision processing units(s) (VPUs), and/or field programmable logic device(s) (FPLD(s)) such as FPGAs in combination with machine readable instructions (e.g., firmware or software). Further still, the example the thread(s) 106, 108, the compute element 110, and/or the caching agent 114 of FIGS. 2, 3, and/or 4 may include one or more elements, processes, and/or devices in addition to, or instead of, those illustrated in FIGS. 2, 3, and/or 4, and/or may include more than one of any or all of the illustrated elements, processes and devices.

Flowchart(s) representative of example machine readable instructions, which may be executed by programmable circuitry to implement and/or instantiate the thread(s) 106, 108, the compute element 110, and/or the caching agent 114 of FIGS. 2, 3, and/or 4 and/or representative of example operations which may be performed by programmable circuitry to implement and/or instantiate the thread(s) 106, 108, the compute element 110, and/or the caching agent 114 of FIGS. 2, 3, and/or 4, are shown in FIGS. 6 and/or 7. The machine readable instructions may be one or more executable programs or portion(s) of one or more executable programs for execution by programmable circuitry such as the programmable circuitry 1012 shown in the example processor platform 1000 discussed below in connection with FIG. 10 and/or may be one or more function(s) or portion(s) of functions to be performed by the example programmable circuitry (e.g., an FPGA) discussed below in connection with FIGS. 11 and/or 12. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 6 and/or 7, many other methods of implementing the example the example the thread(s) 106, 108, the compute element 110, and/or the caching agent 114 of FIGS. 2, 3, and/or 4 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, chiplet(s), discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, a chiplet and/or an array of chiplets, etc.)). As used herein, programmable circuitry includes any type(s) of circuit that may be programmed to perform a desired function such as, for example, a CPU, a core, a chiplet, an array of chiplets, a GPU, a VPU, and/or an FPGA. The programmable circuitry may include one or more CPUs, one or more cores, one or more chiplets, one or more GPUs, one or more VPUs, and/or one or more FPGAs located in the same package (e.g., the same integrated circuit (IC) package or in two or more separate housings), one or more one or more CPUs, one or more cores, one or more chiplets, one or more GPUs, one or more VPUs, and/or one or more FPGAs in a single machine, multiple CPUs, cores, chiplets, GPUs, VPUs, and/or FPGAs distributed across multiple servers of a server rack, and/or multiple CPUs, cores, chiplets, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 6 and/or 7 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 6 is a flowchart representative of example machine readable instructions and/or example operations 600 that may be executed, instantiated, and/or performed by programmable circuitry to facilitate temporary coherency for a memory range using the compute element 110 of FIG. 3. The example machine-readable instructions and/or the example operations 600 of FIG. 6 begin at block 602, at which the memory mode tracking circuitry 302 determines if a coherency instruction has been obtained via the interface circuitry 300 and/or executed by the instruction extension execution circuitry 306. A coherency instruction is an instruction included in a thread that the instruction extension execution circuitry 306 can execute to tag a section of memory (e.g., a memory object or memory range) with a coherency model for one or more threads, compute elements, chiplet, and/or IO devices. The coherency instruction may correspond to the first five instructions included in the above-Table 1 and/or the values stored in the MSRs for the first five action types in the above Table 2.

If the memory mode tracking circuitry 302 determines that a coherency instruction has not been obtained/executed (block 602: NO), control continues to block 610. If the memory mode tracking circuitry 32 determines that a coherency instruction has been obtained/executed (block 602: YES), the memory mode tracking circuitry 302 uses the interface circuitry 300 to transmit a set coherency request to the caching agent 114 to configure a coherency setting for a memory object based on the coherency instruction (block 604). For example, the memory mode tracking circuitry 302 can generate a coherence request identifying the memory range, the type of coherent protocol used, the threads, compute elements, chiplets, and/or IO devices that are mapped to the coherency memory mode, a service level objective, etc. The interface circuitry 300 transmits the coherency request to the caching agent 114, which tags and/or tracks the coherency of memory objects and facilitates operation based on the tagged and/or tracked coherency of the memory objects.

At block 606, the memory mode tracking circuitry 302 determines if a revert coherency (also referred to as a reset coherence or end coherence) instruction has been objected by the interface circuitry 300 and/or executed by the instruction extension execution circuitry 306. The revert coherency is an instruction that reverts the temporary coherency model for a memory object back to a default coherency (e.g., no coherency) and corresponds to the sixth instruction of the above-Table 1 and/or the MSR values of the sixth action type of the above-Table 2. If the memory mode tracking circuitry 302 determines that a revert coherency instruction has not been obtained/executed (block 606: NO), control continues to block 610. If the memory mode tracking circuitry 302 determines that a revert coherency instruction has been obtained/executed (block 606: YES), the memory mode tracking circuitry 302 uses the interface circuitry 300 to transmit a revert coherency request to the caching agent 114 to revert the coherency setting for a memory object to a default coherency protocol and/or model corresponding to the memory address range identified in the revert coherency instruction (block 608).

At block 610, the instruction extension execution circuitry 306 determines if an access instruction has been obtained. An access instruction is an instruction to access data corresponding to a memory address or memory line. The access instruction may correspond to a read instruction, a write instruction, a manipulate instruction (e.g., add, multiply, modify, etc.), etc. The execution may be part of the instructions of an application or thread. If the instruction extension execution circuitry 306 determines that the access instruction has not been obtained (block 610: NO), control returns to block 602. If the instruction extension execution circuitry 306 determines that the access instruction has been obtained (block 612: YES), the interface circuitry 300 transmits an access request corresponding to the instruction to the caching agent 114 (block 612). As further described below, the caching agent 114 can grant or deny the access instruction based on the memory mode for the memory address of the access instruction.

At block 614, the instruction extension execution circuitry 204 determines if an acknowledgement granting permission has been obtained from the caching agent 114 via the interface circuitry 300. If the instruction extension execution circuitry 204 determines that an acknowledgment granting permission has not been received (block 614: NO), control returns to block 602. In some examples, the instruction extension execution circuitry 306 can discard the instruction, retry the instruction, and/or save the instruction to retry at a different point in time. If the instruction extension execution circuitry 204 determines that an acknowledgment granting permission has been received (block 614: YES), the instruction extension execution circuitry 306 performs the access operation (block 616).

FIG. 7 is a flowchart representative of example machine readable instructions and/or example operations 700 that may be executed, instantiated, and/or performed by programmable circuitry to facilitate temporary coherency for a memory range using the caching agent 114 of FIG. 4. The example machine-readable instructions and/or the example operations 700 of FIG. 7 begin at block 702, at which the system address decoder circuitry 402 determines if a coherency request has been obtained (e.g., accessed, received, etc.) via the interface circuitry 400. As described above, a coherency request is generated by the compute element 110 when executing a coherency instruction that identifies memory mode configurations for a memory address range. The coherency request may be a set coherency request or a revert coherency request. The set coherency request is a request to configure coherency for a memory object. revert coherency request is a request to remove coherency from a previously set memory object.

If the system address decoder circuitry 402 determines that a coherency request has not been obtained (block 702: NO), control continues to block 706. If the system address decoder circuitry 402 determines that a coherency request has been obtained (block 702: YES), the system address decoder circuitry 402 applies a coherency model by configuring the coherency setting for the memory range based on the coherency request (block 704). For example, the system address decoder circuitry 402 can configure the coherency setting for the memory range by tagging or otherwise tracking the coherency details and/or implementing coherency for the memory range based on the coherency details, as further described above in conjunction with FIG. 4. The system address decoder circuitry 402 identifies the memory range in the coherency request based on the information included in the coherency request. The coherency request may identify the memory range, a coherent protocol type for implementing a coherency model, the coherency model, and/or a bitmask identifying which threads, compute elements, IO devices, and/or chiplets are to utilize the coherent protocol. The coherency request may be a set coherency request or a revert coherency request. The system address decoder circuitry 402 ensures that coherency is implemented for the memory range identified in the coherency request based on the details of the coherency request until the coherency for the memory range is reset. In some examples, for a set coherency request, the system address decoder circuitry 402 may store an entry corresponding to the coherency request and/or tags a memory object corresponding to a memory address range identified in the coherency request, based on the coherency information included in the coherency request. Alternatively, the system address decoder circuitry 402 may store the coherency request and lookup the coherency request information in response to an access request to a memory address included in the memory range of the coherency request. The system address decoder circuitry 402 may tag and/or track the memory range based on the information corresponding to the coherency request, as opposed to creating an entry. In some examples, the coherency request is a request to end and/or reset coherency for a previously tagged memory range. In such examples, the system address decoder circuitry 402 removes the entry for the memory range, untags the memory range for coherency, and/or stops implementing coherency for the memory range.

At block 706, the coherency logic circuitry 406 determines if the interface circuitry 400 has obtained an access request from the compute element 110. As described above, the access request corresponds to a read operation, a write operation, or a manipulation operation to data at a memory address based on an instruction being executed by the compute element 110. If the coherency logic circuitry 406 determines that an access request has not been obtained (block 706: NO), control returns to block 702. If the coherency logic circuitry 406 determines that an access request has been obtained (block 706: YES), the system address decoder circuitry 402 determines whether the access request corresponds to a coherency-based memory object (block 708). A coherency-based memory object is a memory object corresponding to a range of memory addresses that has been tagged or being tracked as corresponding to a coherency model. Because the system address decoder circuitry 402 tracks the coherency-based memory objects based on obtained coherency requests, the system address decoder circuitry 402 can determine if the access request is for a memory address that is within a memory range or memory objected tagged as coherent.

If the system address decoder circuitry 402 determines that the access request corresponds to a memory object tagged as coherent (block 708: YES), control continues to block 712. If the system address decoder circuitry 402 determines that the access request does not correspond to a memory object tagged as coherent (block 708: NO), the coherency logic circuitry 406 instructs the interface circuitry 400 to transmit an acknowledgement to the compute element 110 granting access to the request (block 710). In this manner, the compute element 110 can execute the access instruction. At block 712, the coherency logic circuitry 406 determines if the coherency characteristic for the memory object that includes the memory address identified in the access request corresponds to coherency logic for the compute element that provided the access request. For example, if the memory object corresponds to a bitmask that identifies coherency for particular compute elements, IO devices, chiplets, threads, etc. the coherency logic circuitry 406 determines whether the compute element and/or thread that transmitted the access request is identified by the bitmask as adhering to coherency.

If the coherency logic circuitry 406 determines that the coherency characteristics correspond to coherency for the compute element and/or thread that provided the access request (block 712: YES), control continues to block 720. If the coherency logic circuitry 406 determines that the coherency characteristics do not correspond to coherency for the compute element and/or thread that provided the access request (block 712: NO), the coherency logic circuitry 406 determines if the access request corresponding to modifying data of the memory object (e.g., such as a write operation, a manipulate operation, a read modify write operation, etc.) (block 714). If the coherency logic circuitry 406 determines that the access request does not correspond to modifying the memory object (e.g., the access request corresponds to a read operation) (block 714: NO), the coherency logic circuitry 406 instructs the interface circuitry 400 to transmit an acknowledgement to the compute element 110 granting the access request (block 716) and control returns to block 702. In this manner, the compute element 110 can proceed with the read operation to the memory address.

If the coherency logic circuitry 406 determines that the access request corresponds to modifying the memory object (block 714: YES), the coherency logic circuitry 406 instructs the interface circuitry 400 to transmit an acknowledgement to the compute element 110 denying the access request (block 718) and control returns to block 702. If the coherency logic circuitry 406 determines that the coherency characteristics corresponds to coherency for the compute element and/or thread that provided the access request (block 712: YES), the coherency logic circuitry 406 and/or the snoop filtering circuitry 404 facilitate the access request according to the coherency model for the coherency-based object (block 720) and control returns to block 702. As described above, the coherency model may include snooping, causing data to be flushed from all other caches for other compute elements, promoting the thread and/or compute element to owner of the memory address for a modification of the data, etc.

FIGS. 8, 9A, 9B, and 10 include example computing architectures in which any of the techniques and configurations above may be implemented.

FIG. 8 illustrates an example hardware arrangement of an example data center 800 used to provide multiple examples or instances of a computing system (e.g., the programmable circuitry platform 1000, described below), with each example of the computing system identified as a respective platform (e.g., the platform 830, described below). The data center 800 includes example data center infrastructure 801, an example data center network fabric 802, and an example power distribution unit 803 to support multiple racks of compute platforms, with a single instance of an example rack 810 depicted. The data center infrastructure 801 may provide physical components that host the compute platform hardware, storage components, and/or networking equipment. The data center network fabric 802 may include switches and/or networking components to support data flows among various compute platforms and storage devices throughout the data center. The power distribution unit 803 may include components to distribute and/or control power among the various compute platforms, networking, and storage devices.

The rack 810 of FIG. 8 includes, but is not limited to, example cooling infrastructure 811, an example network interface 812, and/or other related physical components to support discrete instances of multiple chassis. The rack 810 provides power, connectivity, and/or cooling to each of the multiple chassis in a single rack, with a single instance of a chassis 820 in the example of FIG. 8. The chassis 820 includes, but is not limited to, example cooling infrastructure 821, an example chassis network fabric 822, and an example power supply 823, which provides cooling, network connectivity, and/or power to multiple platforms within the chassis. Although a single instance of an example platform 830 is illustrated in FIG. 8, in some examples, a common data center rack configuration may include dozens of chassis, with each chassis to support a number of platforms depending on the physical size of the platform hardware and/or supporting equipment.

The platform 830 of FIG. 8 may be referred to as a server or node, depending on the use case for the platform 830 and the data center 800. The platform 830 includes but is not limited to examples of a discrete computing system hosted on a single board. In FIG. 8, the platform 830 is illustrated as hosting a first example chip assembly 840A and a second example chip assembly 840B on a first board provided by a printed circuitry board (PCB) or other platform board, shown as an example PCB 831. In some examples, the platform 830 may include only one chip package, whereas the PCB 831 includes interconnection of multiple chip assemblies via an interface (e.g., a peripheral component interconnect express (PCIe) interface). Additional chip packages and components may also be hosted on the PCB 831.

Some examples of the chip assembly 840A, 840B of FIG. 8 may be termed as a System-on-Chip (SoC) package, as modular chiplets that perform different functions are integrated into a single package-even though this chip package is composed of multiple dies unlike a traditional SoC design that uses a single die. Other examples of the chip assembly 840A, 840B may include a System-on-Package (SoP), System-in-a-Package (SiP), or other single chip packages. Various combinations of 2 dimension (D), 2.5D, and/or 3D packaging technologies may be used to manufacture and/or assemble the chip package and its underlying structure. Additionally, different manufacturing processes may be used to provide chiplets and components from different process nodes (e.g., semiconductor fabrication systems).

The first chip assembly 840A and the second chip assembly 840B of FIG. 8 are packages that include multiple chiplets and/or dies for respective functions, such as separate chiplets for processing (e.g., central processing unit (CPU) or graphical processing unit (GPU) chiplets), memory (e.g., cache or high-bandwidth memory chiplets), input/output (I/O) (e.g., I/O chiplets), acceleration (e.g., artificial intelligence (AI)/machine learning (ML) acceleration chiplets), signal processing (e.g., audio or video processing chiplets), etc. The close-up of chip assembly 840A of FIG. 8 includes a I/O Hub chiplet 841, chiplets 842, and a power supply 843. These components may be hosted on an interposer that is designed to connect multiple dies and/or components within a single semiconductor package (e.g., chip package). In some examples, the chiplets 842 may be manufactured and/or sourced separately and later assembled into the chip package to create the chip assembly 840A. Various connections may be provided among the chiplets 842, such as with the use of Universal Chiplet Interconnect Express (UCIe) interfaces and communications, and/or between chiplets and on-chip memory (e.g., high-bandwidth memory (HBM)) using HBM3 (JEDEC), Universal Memory Interface (UMI), or other memory interfaces.

FIG. 9A illustrates an example arrangement of an example chip assembly 940A (e.g., a multi-processing core example of the first chip assembly 840A or the second chip assembly 840B of FIG. 8), with expanded views of the chiplets and processing units included herein. In FIG. 9A the chip assembly 940A, which may constitute a SoC, SoP, SiP, and/or other type of chip package, includes chiplets such as an example chiplet 910A, an example chiplet 910B, etc. and associated on-package memory (e.g., high-speed memory) such as 3D-stacked, High Bandwidth Memory (HBM) instances (shown as an example HBM 920A, an example HBM 920B, interfaces (e.g., UCle interfaces) shown as an example UCle 921A, an example UCle 921B, and an example I/O hub 930 (e.g., which may be implemented by a I/O chiplet). Other hardware elements of a chip package are not included for simplicity. Although the examples disclosed herein are described in conjunction with UCLe interfaces, one or more of the interfaces may be device-to-device (Dev2Dev) interfaces (e.g., CXLI, peripheral component interconnect express (PCIE)), die to die (D2D) interfaces (e.g., NVLINK), chiplet to chiplet (Ch2Ch) interfaces (e.g., universal chiplet interconnected express (UCIe)), core to core (C2C) interfaces (e.g., using coherency models), etc.

The chiplets 910A, 910B of FIG. 9A include multiple processing units and the example processing units 900A, 900B, 900C, 900D include one or multiple cores, respectively. For example, the chiplet 910A of FIG. 9A includes four processing units (the processing units 900A, 900B, 900C, 900D) and an example Level 3 (L3) cache 904. The processing units 900A, 900B, 900C, 900D may include one or multiple processing cores, one or multiple caches, other processing units and/or passive and/or active elements. For example, processing unit 900A includes two cores (an example core 901A and an example core 901B), vector processing unit 902, and an example level 2 (L2) cache 903. Accordingly, a single-core processing unit can provide four cores per chiplet and eight total cores in a two-chiplet chip assembly, whereas a dual-core processing unit can provide eight cores per chiplet and sixteen total cores in a two-chiplet chip assembly. However, examples disclosed herein may correspond to other permutations.

FIG. 9B is an example arrangement of an example chip assembly 940B (e.g., a multi-chiplet high-performance computing (HPC) example of chip assembly 840A, 840B), adapted for HPC applications (e.g., parallel processing operations involving thousands, millions, or more of processors and/or cores operating simultaneously). The example chip assembly 940B illustrates placement as a SiP, SoC, and/or other package onto a platform board (e.g., the PCB 831 of FIG. 8). The platform board may be in a data center (e.g., the data center 800 of FIG. 8) or in a standalone deployment setting (e.g., in a standalone computer system, mobile computing device, autonomous device, etc.).

The chip assembly 940B of FIG. 9B is composed of multiple chiplets, shown with four chiplets, including example chiplets 910C, 910D, 910E, 910F. The chiplets 910C, 910D, 910E, 910F include multiple processing units, such as thirty-two processing units with a corresponding level 3 (L3) cache for each processing unit. The processing units may include one or multiple cores, such as an example single-core processing unit 900E shown as part of the chiplet 910C. The chip assembly 940B also includes corresponding memory resources, such as HBM elements corresponding to respective banks of processing units (e.g., HBM 920B and HBM 920C corresponding respective sets of processing units of chiplet 910C), UCle interfaces, and/or an IO Hub.

The chip assembly and related products or devices described herein may be configured in a variety of computing system examples. Such examples include non-transitory machine-readable media storing machine-readable instructions and one or more processors coupled to the memory, such that executing the machine-readable instructions configure one or more of the processors and/or implementing hardware (e.g., the processing unit 900, the chiplet 910, the chip 840, and/or the platform 830 of FIGS. 8, 9A, and/or 9B) to perform operations described above for electronic systems or devices (e.g., to facilitate the use of dynamic memory modes, etc.). It should be further understood that software, including one or more machine readable instructions, that facilitate processing and operations as described above may be distributed, installed, or otherwise provided to networked devices (e.g., servers or cloud computing systems). Alternatively, in some examples, the software may be obtained and loaded (or, re-loaded/upgraded) from one or more servers and/or cloud computing systems, such as software stored on a server for distribution over the Internet, for example.

FIG. 10 is a block diagram of an example programmable circuitry platform 1000 structured to execute and/or instantiate the example machine-readable instructions and/or the example operations of FIGS. 6 and/or 7 to implement the example the thread(s) 106, 108, the compute element 110, and/or the caching agent 114 of FIGS. 2, 3, and/or 4. The programmable circuitry platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a gaming console, or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAs, microprocessors, CPUs, GPUs, DSPs, and/or microcontrollers from any desired family or manufacturer. In some examples, the programmable circuitry 1012 can be implemented by reduced instruction set computer (RISC)-V architecture and/or a chiplet (e.g., the chiplet assemblies 840A, 840B, 940A, 940B of FIGS. 9, 10A and/or 10B). The programmable circuitry 1012 may be implemented by one or more semiconductor based (e.g., silicon based) devices. In this example, the programmable circuitry 1012 implements the memory runtime and libraries APIs, the operating system page table 202, the memory mode tracking circuitry 302, the coherency determination circuitry 304, the instruction extension execution circuitry 306, the system address decoder circuitry 402, the snoop filtering circuitry 404, and the coherency logic circuitry 406 of FIGS. 2-4.

In some examples, the hardware of the circuitry may include variably connected physical components (e.g., execution units, transistors, simple circuits, etc.) including a machine-readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the machine-readable medium elements can be part of the circuitry or communicatively coupled to the other components of the circuitry when the device is operating. Also, in some examples, any of the physical components may be used in more than one member of more than one circuitry. For example, under operation, execution units may be used in a first circuit of first circuitry at one point in time and reused by a second circuit in the first circuitry, or by a third circuit in a second circuitry at a different time.

The programmable circuitry 1012 of the illustrated example includes a local memory 1013 (e.g., a cache, registers, etc.). The programmable circuitry 1012 of the illustrated example is in communication with main memory 1014, 1016, which includes a volatile memory 1014 and a non-volatile memory 1016, by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016.

The programmable circuitry platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In some examples, the interface circuitry 1020 may include an output interface, such as an interface connected to a display device, an input interface such as an interface connected to an alphanumeric input device or a user interface (UI) navigation device, or a communication interface. In some examples, a connected I/O device may also include a display device, an alphanumeric input device, and/or a navigation device that is integrated into a single unit, such as a touch screen display. The communication interface may provide a connection with a network interface device used to transmit and/or receive electronic signals on the network 1026. The programmable circuitry platform 1000 may also include other interfaces or hardware in connection with a signal generation device (e.g., an audio or radio signal generation device), an output controller (e.g., for connection with a serial, universal serial bus (USB), parallel, and/or other wired or wireless connection such as which uses via infrared (IR) and/or near field communication (NFC) technologies), an input controller (e.g., for connection with sensors or peripheral devices), etc. In some examples, the interface circuitry 1020 may implement the interface circuitry 300, 400 of FIGS. 3 and/or 4.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example, an audio sensor, a microphone, a camera (still or video), a keyboard, a button, a mouse, a touchscreen, and/or a voice recognition system.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), and/or a tactile output device. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1000 of the illustrated example also includes one or more mass storage discs or devices 1028 to store firmware, software, and/or data. Examples of such mass storage discs or devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1032, which may be implemented by the machine readable instructions of FIGS. 6 and/or 7, may be stored in the mass storage device 1028, in the volatile memory 1014, in the non-volatile memory 1016, and/or on at least one non-transitory computer readable storage medium such as a CD or DVD which may be removable. Some examples of a machine-readable medium are a non-transitory medium that hosts or stores one or more sets of data structures or instructions (e.g., software instructions) embodying or utilized by any one or more of the techniques or functions described herein. Such instructions are collectively labeled as instructions 1032.

The instructions 1032 may reside, during execution and/or other operation of the programmable circuitry platform 1000, completely, or at least partially, within the volatile memory 1014, within non-volatile memory 1016, within the local memory 1013, within a removable storage, within a non-removable storage, and/or within the programmable circuitry 1012. Thus, any combination of the programmable circuitry 1012, the volatile memory 1014, the non-volatile memory 1016, the local memory 1013, and/or a storage device of the removable storage or non-removable storage may constitute a machine-readable medium or media. The instructions 1032, when loaded and executed by the programmable circuitry 1012, may invoke or utilize a defined instruction set 1032 of the programmable circuitry 1012, such as a processor instruction set defined by an instruction set architecture (ISA) of a reduced instruction set computer (RISC) or complex instruction set computer (CISC) architecture-including but not limited to the RISC-V Instruction Set provided in a RISC-V architecture. A RISC-V architecture and instruction set is one of several available architectures and instruction sets that may be used in examples of the compute components (e.g., the programmable circuitry 1012) described herein.

FIG. 11 is a block diagram of an example implementation of the programmable circuitry 1012 of FIG. 10. In this example, the programmable circuitry 1012 of FIG. 10 is implemented by a microprocessor 1100. For example, the microprocessor 1100 may be a general-purpose microprocessor (e.g., general-purpose microprocessor circuitry). The microprocessor 1100 executes some or all of the machine-readable instructions of the flowcharts of FIGS. 6 and/or 7 to effectively instantiate the circuitry of FIGS. 2-4 as logic circuits to perform operations corresponding to those machine readable instructions. In some such examples, the circuitry of FIGS. 2-4 is instantiated by the hardware circuits of the microprocessor 1100 in combination with the machine-readable instructions. For example, the microprocessor 1100 may be implemented by multi-core hardware circuitry such as a CPU, a DSP, a GPU, a VPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine readable instructions and/or operations represented by the flowcharts of FIGS. 6 and/or 7.

The cores 1102 may communicate by a first example bus 1104. In some examples, the first bus 1104 may be implemented by a communication bus to effectuate communication associated with one(s) of the cores 1102. For example, the first bus 1104 may be implemented by at least one of an Inter-Integrated Circuit (I2C) bus, a Serial Peripheral Interface (SPI) bus, a PCI bus, or a PCIe bus. Additionally or alternatively, the first bus 1104 may be implemented by any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2 cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the local memory 1120, and a second example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer based operations. In other examples, the AL circuitry 1116 also performs floating-point operations. In yet other examples, the AL circuitry 1116 may include first AL circuitry that performs integer-based operations and second AL circuitry that performs floating-point operations. In some examples, the AL circuitry 1116 may be referred to as an Arithmetic Logic Unit (ALU).

The registers 1118 are semiconductor-based structures to store data and/or instructions such as results of one or more of the operations performed by the AL circuitry 1116 of the corresponding core 1102. For example, the registers 1118 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure, such as by being distributed throughout the core 1102 to shorten access time. The second bus 1122 may be implemented by at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages.

The microprocessor 1100 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1100, in the same chip package as the microprocessor 1100 and/or in one or more separate packages from the microprocessor 1100.

FIG. 12 is a block diagram of another example implementation of the programmable circuitry 1012 of FIG. 10. In this example, the programmable circuitry 1012 is implemented by FPGA circuitry 1200. For example, the FPGA circuitry 1200 may be implemented by an FPGA. The FPGA circuitry 1200 can be used, for example, to perform operations that could otherwise be performed by the example microprocessor 1100 of FIG. 11 executing corresponding machine readable instructions. However, once configured, the FPGA circuitry 1200 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1100 of FIG. 11 described above (which is a general purpose device that may be programmed to execute some or all of the machine readable instructions represented by the flowchart(s) of FIGS. 6 and/or 7 but whose interconnections and logic circuitry are fixed once fabricated), the FPGA circuitry 1200 of the example of FIG. 12 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 6 and/or 7. In particular, the FPGA circuitry 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 6 and/or 7. As such, the FPGA circuitry 1200 may be configured and/or structured to effectively instantiate some or all of the operations/functions corresponding to the machine readable instructions of the flowchart(s) of FIGS. 6 and/or 7 as dedicated logic circuits to perform the operations/functions corresponding to those software instructions in a dedicated manner analogous to an ASIC. Therefore, the FPGA circuitry 1200 may perform the operations/functions corresponding to the some or all of the machine readable instructions of FIGS. 6 and/or 7 faster than the general-purpose microprocessor can execute the same.

In the example of FIG. 12, the FPGA circuitry 1200 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

The FPGA circuitry 1200 of FIG. 12, includes example input/output (I/O) circuitry 1202 to obtain and/or output data to/from example configuration circuitry 1204 and/or external hardware 1206. For example, the configuration circuitry 1204 may be implemented by interface circuitry that may obtain a binary file, which may be implemented by a bit stream, data, and/or machine-readable instructions, to configure the FPGA circuitry 1200, or portion(s) thereof. In some such examples, the configuration circuitry 1204 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1206 may be implemented by external hardware circuitry. For example, the external hardware 1206 may be implemented by the microprocessor 1100 of FIG. 11.

The FPGA circuitry 1200 also includes an array of example logic gate circuitry 1208, a plurality of example configurable interconnections 1210, and example storage circuitry 1212. The logic gate circuitry 1208 and the configurable interconnections 1210 are configurable to instantiate one or more operations/functions that may correspond to at least some of the machine readable instructions of FIGS. 6 and/or 7 and/or other desired operations. The logic gate circuitry 1208 shown in FIG. 12 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations/functions. The logic gate circuitry 1208 may include other electrical structures such as look-up tables (LUTs), registers (e.g., flip-flops or latches), multiplexers, etc.

The configurable interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example dedicated operations circuitry 1214. In this example, the dedicated operations circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the programmable circuitry 1012 of FIG. 10, many other approaches are contemplated. For example, FPGA circuitry may include an on-board CPU, such as one or more of the example CPU 1220 of FIG. 11. Therefore, the programmable circuitry 1012 of FIG. 10 may additionally be implemented by combining at least the example microprocessor 1100 of FIG. 11 and the example FPGA circuitry 1200 of FIG. 12. In some such hybrid examples, one or more cores 1102 of FIG. 11 may execute a first portion of the machine readable instructions represented by the flowchart(s) of FIGS. 6 and/or 7 to perform first operation(s)/function(s), the FPGA circuitry 1200 of FIG. 12 may be configured and/or structured to perform second operation(s)/function(s) corresponding to a second portion of the machine readable instructions represented by the flowcharts of FIGS. 6 and/or 7, and/or an ASIC may be configured and/or structured to perform third operation(s)/function(s) corresponding to a third portion of the machine readable instructions represented by the flowcharts of FIGS. 6 and/or 7.

It should be understood that some or all of the circuitry of FIGS. 2-4 may, thus, be instantiated at the same or different times. For example, same and/or different portion(s) of the microprocessor 1100 of FIG. 11 may be programmed to execute portion(s) of machine-readable instructions at the same and/or different times. In some examples, same and/or different portion(s) of the FPGA circuitry 1200 of FIG. 12 may be configured and/or structured to perform operations/functions corresponding to portion(s) of machine-readable instructions at the same and/or different times.

In some examples, some or all of the circuitry of FIGS. 2-4 may be instantiated, for example, in one or more threads executing concurrently and/or in series. For example, the microprocessor 1100 of FIG. 11 may execute machine readable instructions in one or more threads executing concurrently and/or in series. In some examples, the FPGA circuitry 1200 of FIG. 12 may be configured and/or structured to carry out operations/functions concurrently and/or in series. Moreover, in some examples, some or all of the circuitry of FIGS. 2-4 may be implemented within one or more virtual machines and/or containers executing on the microprocessor 1100 of FIG. 11.

In some examples, the programmable circuitry 1012 of FIG. 10 may be in one or more packages. For example, the microprocessor 1100 of FIG. 11 and/or the FPGA circuitry 1200 of FIG. 12 may be in one or more packages. In some examples, an XPU may be implemented by the programmable circuitry 1012 of FIG. 10, which may be in one or more packages. For example, the XPU may include a CPU (e.g., the microprocessor 1100 of FIG. 11, the CPU 1220 of FIG. 12, etc.) in one package, a DSP (e.g., the DSP 1222 of FIG. 12) in another package, a GPU in yet another package, and an FPGA (e.g., the FPGA circuitry 1200 of FIG. 12) in still yet another package.

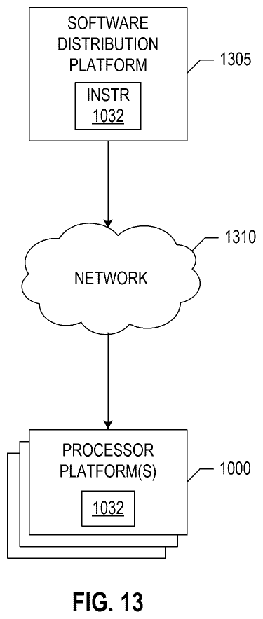

A block diagram illustrating an example software distribution platform 1305 to distribute software such as the example machine readable instructions 1032 of FIG. 10 to other hardware devices (e.g., hardware devices owned and/or operated by third parties from the owner and/or operator of the software distribution platform) is illustrated in FIG. 13. The example software distribution platform 1305 may be implemented by any computer server, data facility, cloud service, etc., capable of storing and transmitting software to other computing devices. The third parties may be customers of the entity owning and/or operating the software distribution platform 1305. For example, the entity that owns and/or operates the software distribution platform 1305 may be a developer, a seller, and/or a licensor of software such as the example machine readable instructions 1032 of FIG. 10. The third parties may be consumers, users, retailers, OEMs, etc., who purchase and/or license the software for use and/or re-sale and/or sub-licensing. In the illustrated example, the software distribution platform 1305 includes one or more servers and one or more storage devices. The storage devices store the machine readable instructions 1032, which may correspond to the example machine readable instructions of FIGS. 6 and/or 7, as described above. The one or more servers of the example software distribution platform 1305 are in communication with an example network 1310, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1032 from the software distribution platform 1305. For example, the software, which may correspond to the example machine readable instructions of FIGS. 6 and/or 7, may be downloaded to the example programmable circuitry platform 1000, which is to execute the machine readable instructions 1032 to implement the example the thread(s) 106, 108, the compute element 110, and/or the caching agent 114 of FIGS. 2, 3, and/or 4. In some examples, one or more servers of the software distribution platform 1305 periodically offer, transmit, and/or force updates to the software (e.g., the example machine readable instructions 1032 of FIG. 10) to ensure improvements, patches, updates, etc., are distributed and applied to the software at the end user devices. Although referred to as software above, the distributed “software” could alternatively be firmware.

The instructions 1032 may be transmitted or received over the network 1310 using a transmission medium via the interface circuitry 1020 of FIG. 10 and related devices utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and/or wireless data networks (e.g., Institute of Electrical and Electronics Engineers (IEEE) 802.11 family of standards known as Wi-Fi®), IEEE 802.15.4 family of standards, peer-to-peer (P2P) networks, among others.

A computing program may be written in any form of programming language, including compiled or interpreted languages, and it may be deployed in any form, including as a stand-alone program and/or as a module, component, subroutine, and/or other unit suitable for use in a computing environment. Also, programs, codes, and/or code segments for accomplishing the techniques described herein are construed as within the scope of the present disclosure by programmers of ordinary skill in the art.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system-on-chip (SoC), etc.

From the foregoing, it will be appreciated that example systems, apparatus, articles of manufacture, and methods have been disclosed that facilitate the use of dynamic coherency models for memory objects (e.g., memory objects that can be tagged for a coherency model or for consistency (e.g., no coherency)). Disclosed systems, apparatus, articles of manufacture, and methods improve the efficiency of using a computing device by dynamically subjecting memory objects to coherence when needed and removing coherence for the memory objects when not needed. In this manner, examples disclosed herein can reduce overhead and/or resources when coherency is not needed. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to facilitate use of dynamic coherency models for memory objects are disclosed herein. Further examples and combinations thereof include the following:

Example 1 includes an apparatus comprising interface circuitry, instructions, and at least one programmable circuit to be programmed by the instructions to access a request identifying a memory range and a coherency model, and apply the coherency model to a memory address in the memory range based on the coherency model setting.

Example 2 includes the apparatus of one or more of the proceeding Examples, wherein one or more or the at least one programmable circuit is to configure a coherency setting for the memory range based on the request.

Example 3 includes the apparatus of one or more of the proceeding Examples, wherein the request includes a bitmask that identifies compute elements that are to implement the coherency model for the memory range.

Example 4 includes the apparatus of one or more of the proceeding Examples, wherein one or more of the at least one programmable circuit is to configure a coherency setting corresponding to the coherency model by storing an entry including the memory range and an identifier of the coherency model.

Example 5 includes the apparatus of one or more of the proceeding Examples, wherein one or more of the at least one programmable circuit is to configure a coherency setting corresponding to the coherency model by tagging the memory range.

Example 6 includes the apparatus of one or more of the proceeding Examples, wherein one or more of the at least one programmable circuit is to reset a coherency setting corresponding to the coherency model to a default coherency protocol, based on a reset coherency request.

Example 7 includes the apparatus of one or more of the proceeding Examples, wherein the interface circuitry is to receive the request from a compute element, the request generated based on a coherency instruction executed by the compute element.

Example 8 includes the apparatus of one or more of the proceeding Examples, wherein one or more of the at least one programmable circuit is to determine that a request to access the memory address corresponds to a coherency setting corresponding to the coherency model based on the memory address being within the memory range.

Example 9 includes a non-transitory computer readable medium comprising instructions which cause at least one programmable circuit to at least access a request identifying a memory range and a coherency model, and apply the coherency model to a memory address in the memory range based on the coherency model setting.

Example 10 includes the non-transitory computer readable medium of one or more of the proceeding Examples, wherein the instructions cause one or more of the at least one programmable circuit to configure a coherency setting for the memory range based on the request.

Example 11 includes the non-transitory computer readable medium of one or more of the proceeding Examples, wherein the request includes a bitmask that identifies processor elements that are to implement the coherency model for the memory range.

Example 12 includes the non-transitory computer readable medium of one or more of the proceeding Examples, wherein the instructions cause one or more of the at least one programmable circuit to configure a coherency setting corresponding to the coherency model by storing an entry including the memory range and an identifier of the coherency model.

Example includes the non-transitory computer readable medium of one or more of the proceeding Examples, wherein the instructions cause one or more of the at least one programmable circuit to configure a coherency setting corresponding to the coherency model by tagging the memory range as coherent.

Example 14 includes the non-transitory computer readable medium of one or more of the proceeding Examples, wherein the instructions cause one or more of the at least one programmable circuit to reset a coherency setting corresponding to the coherency model to a default coherency protocol based on a revert coherency request.

Example 15 includes the non-transitory computer readable medium of one or more of the proceeding Examples, wherein the instructions cause one or more of the at least one programmable circuit to receive the request from a processor element, the request generated based on a coherency instruction executed by the processor element.

Example 16 includes the non-transitory computer readable medium of one or more of the proceeding Examples, wherein the instructions cause one or more of the at least one programmable circuit to determine that a request to access the memory address corresponds to a coherency setting corresponding to the coherency model based on the memory address being within the memory range.

Example 17 includes a method comprising accessing a request identifying a memory range and a coherency model, and applying the coherency model to a memory address in the memory range based on the coherency model setting.

Example 18 includes the method of one or more of the proceeding Examples, including configuring a coherency setting for the memory range based on the request.

Example 19 includes the method of one or more of the proceeding Examples, wherein the request includes a bitmask that identifies central processing units that are to implement the coherency model for the memory range.

Example 20 includes the method of one or more of the proceeding Examples, including configuring a coherency setting corresponding to the coherency model includes storing an entry including the memory range and an identifier of the coherency model.

Example 21 includes the method of one or more of the proceeding Examples, including configuring a coherency setting corresponding to the coherency model includes tagging the memory range as coherent.

Example 22 includes the method of one or more of the proceeding Examples, including resetting a coherency setting corresponding to the coherency model to a default coherency protocol based on a reset coherency request.

Example 23 includes the method of one or more of the proceeding Examples, including receiving the request and from a central processing unit, the request generated based on a coherency instruction executed by the central processing unit.

Example 24 includes the method of one or more of the proceeding Examples, including determining that a request to access the memory address corresponds to a coherency setting corresponding to the coherency model based on the memory address being within the memory range.

Example 25 includes a system comprising a compute element to transmit a first request based on an instruction to implement a coherency model for a memory range, and transmit a second request to access a memory address based on an instruction to perform an operation with data corresponding to the memory address, and a caching agent to configure a coherency setting for the memory range based on the first request, determine if the memory address included in the second request is within the memory range, and facilitate the coherency model for the second request based on the memory address being included in the memory range.

Example 26 includes the system of one or more of the proceeding Examples, wherein the memory address is a first memory address, the caching agent to determine whether a second memory address included in a third request is within the memory range, and grant permission to the third request based on the second memory address being outside the memory range.

Example 27 includes a non-transitory computer readable medium comprising instructions which cause at least one programmable circuit to at least transmit a first request based on an instruction to implement coherency for a memory range, transmit a second request to access a memory address based on an instruction to perform an operation with data corresponding to the memory address, configure a coherency setting for the memory range based on the first request, determine if the memory address included in the second request is within the memory range, and facilitate a coherency model for the second request based on the memory address being included in the memory range.

Example 28 includes the non-transitory computer readable medium of one or more of the proceeding Examples, wherein the memory address is a first memory address, the instructions to cause one or more of the at least one programmable circuit to determine whether a second memory address included in a third request is within the memory range, and grant permission to the third request based on the second memory address being outside the memory range.

Example 29 includes a method comprising transmitting a first request based on an instruction to implement coherency for a memory range, transmitting an second request for a memory address based on an instruction to perform an operation with data corresponding to the memory address, a coherency setting for the memory range based on the first request, determining if the memory address included in the second request is within the memory range, and facilitating a coherency model for the second request based on the memory address being included in the memory range.

Example 30 includes the method of one or more of the proceeding Examples, wherein the memory address is a first memory address, including determining whether a second memory address included in a third request is within the memory range, and granting permission to the third request based on the second memory address being outside the memory range.

Example 31 includes an apparatus comprising means for accessing a request identifying a memory range and a coherency model, and means for applying the coherency model to a memory address in the memory range based on the coherency model setting.

Example 32 includes the apparatus of one or more of the proceeding Examples, including means for configuring a coherency setting for the memory range based on the request.

Example 33 includes the apparatus of one or more of the proceeding Examples, wherein the request includes a bitmask that identifies compute elements that are to implement the coherency model for the memory range.

Example 34 includes the apparatus of one or more of the proceeding Examples, including means for configuring a coherency setting corresponding to the coherency model by storing an entry including the memory range and an identifier of the coherency model.

Example 35 includes the apparatus of one or more of the proceeding Examples, including means for configuring a coherency setting corresponding to the coherency model by tagging the memory range.

Example 36 includes the apparatus of one or more of the proceeding Examples, wherein the means for applying is to reset a coherency setting corresponding to the coherency model to a default coherency protocol, based on a reset coherency request.

Example 37 includes the apparatus of one or more of the proceeding Examples, wherein the means for accessing is to access the request from a compute element, the request generated based on a coherency instruction executed by the compute element.

Example 38 includes the apparatus of one or more of the proceeding Examples, including means for determining that a request to access the memory address corresponds to a coherency setting corresponding to the coherency model based on the memory address being within the memory range.

Example 39 includes a system comprising means for transmitting to transmit a first request based on an instruction to implement a coherency model for a memory range, and transmit a second request to access a memory address based on an instruction to perform an operation with data corresponding to the memory address, and means for configuring to configure a coherency setting for the memory range based on the first request, determine if the memory address included in the second request is within the memory range, and facilitate the coherency model for the second request based on the memory address being included in the memory range.

Example 40 includes the system of one or more of the proceeding Examples, wherein the memory address is a first memory address, the means for configuring to determine whether a second memory address included in a third request is within the memory range, and grant permission to the third request based on the second memory address being outside the memory range.

Example 41 includes machine-readable storage including machine-readable instructions, when executed, to implement a method as claimed in any of the examples 17 to 24 and 29 to 30.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
instructions; and
at least one programmable circuit to be programmed by the instructions to:
access a request identifying a memory range and a coherency model; and
apply the coherency model to a memory address in the memory range based on a coherency setting.

2. The apparatus of claim 1, wherein one or more or the at least one programmable circuit is to configure the coherency setting for the memory range based on the request.

3. The apparatus of claim 1, wherein the request includes a bitmask that identifies compute elements that are to implement the coherency model for the memory range.

4. The apparatus of claim 1, wherein one or more of the at least one programmable circuit is to configure the coherency setting corresponding to the coherency model by storing an entry including the memory range and an identifier of the coherency model.

5. The apparatus of claim 1, wherein one or more of the at least one programmable circuit is to configure the coherency setting corresponding to the coherency model by tagging the memory range.

6. The apparatus of claim 1, wherein one or more of the at least one programmable circuit is to reset the coherency setting corresponding to the coherency model to a default coherency protocol, based on a reset coherency request.

7. The apparatus of claim 1, wherein the interface circuitry is to receive the request from a compute element, the request generated based on a coherency instruction executed by the compute element.

8. The apparatus of claim 1, wherein one or more of the at least one programmable circuit is to determine that a request to access the memory address corresponds to the coherency setting corresponding to the coherency model based on the memory address being within the memory range.

9. A non-transitory computer readable medium comprising instructions which cause at least one programmable circuit to at least:
access a request identifying a memory range and a coherency model; and
apply the coherency model to a memory address in the memory range based on a coherency model setting.

10. The non-transitory computer readable medium of claim 9, wherein the instructions cause one or more of the at least one programmable circuit to configure the coherency setting for the memory range based on the request.

11. The non-transitory computer readable medium of claim 9, wherein the request includes a bitmask that identifies processor elements that are to implement the coherency model for the memory range.

12. The non-transitory computer readable medium of claim 9, wherein the instructions cause one or more of the at least one programmable circuit to configure the coherency setting corresponding to the coherency model by storing an entry including the memory range and an identifier of the coherency model.

13. The non-transitory computer readable medium of claim 9, wherein the instructions cause one or more of the at least one programmable circuit to configure the coherency setting corresponding to the coherency model by tagging the memory range as coherent.

14. The non-transitory computer readable medium of claim 9, wherein the instructions cause one or more of the at least one programmable circuit to reset the coherency setting corresponding to the coherency model to a default coherency protocol based on a revert coherency request.

15. The non-transitory computer readable medium of claim 9, wherein the instructions cause one or more of the at least one programmable circuit to receive the request from a processor element, the request generated based on a coherency instruction executed by the processor element.

16. The non-transitory computer readable medium of claim 9, wherein the instructions cause one or more of the at least one programmable circuit to determine that a request to access the memory address corresponds to the coherency setting corresponding to the coherency model based on the memory address being within the memory range.

17.-30. (canceled)

31. An apparatus comprising:
means for accessing a request identifying a memory range and a coherency model; and
means for applying the coherency model to a memory address in the memory range based on a coherency setting.

32. The apparatus of claim 31, including means for configuring the coherency setting for the memory range based on the request.

33. The apparatus of claim 31, wherein the request includes a bitmask that identifies compute elements that are to implement the coherency model for the memory range.

34. The apparatus of one of claim 31, including means for configuring the coherency setting corresponding to the coherency model by storing an entry including the memory range and an identifier of the coherency model.

35.-41. (canceled)
